(19) United States
(12) Patent Application Publication
(10) Pub. No.: US 2026/0008877 A1
(43) Pub. Date: Jan. 8, 2026

(54) HIGH MOLECULAR WEIGHT AND HIGHLY FUNCTIONAL VINYLIDENE FLUORIDE (VDF) BASED COPOLYMERS

(71) Applicant: Technion Research & Development Foundation Limited, Haifa (IL)

(72) Inventors: Moris EISEN, Haifa (IL); Inbal OZERI, Haifa (IL)

(73) Assignee: Technion Research & Development Foundation Limited, Haifa (IL)

(21) Appl. No.: 18/843,554

(22) PCT Filed: Mar. 21, 2023
(86) PCT No.: PCT/IL2023/050295

§ 371 Date: Sep. 3, 2024

Related U.S. Application Data
(60) Provisional application No. 63/269,691, filed on Mar. 21, 2022.

(51) Int. Cl. C08F 214/22; C08F 2/16; C08F 8/04; C08F 8/12; C08F 8/32; C08F 8/34

(52) U.S. Cl. CPC C08F 214/22; C08F 2/16; C08F 8/04; C08F 8/12; C08F 8/32; C08F 8/34; C08F 2810/50

(57) ABSTRACT

The invention generally concerns high molecular weight and highly functional vinylidene fluoride (VDF)-based copolymers, methods of preparation and uses thereof.

### TECHNOLOGICAL FIELD

The invention generally contemplates novel VDF copolymers and methods for their preparation.

### BACKGROUND OF THE INVENTION

Due to their remarkable chemical and physical properties, fluoropolymers have been extensively used in chemical, electronic, construction, mechanical, architectural, and automotive industries. These unique properties include chemical resistance, weather and thermal stability, inertness to solvents, low dielectric constant, and low moisture absorption. All these outstanding properties are attributed to the low polarizability, strong electronegativity, and small Van der Waals radius (1.32 Å) of the fluorine atom, as well to the strong C—F bonds (BDE=485 kJ/mol). Despite all advantages mentioned above, fluoropolymers exhibit some disadvantages such as high crystallinity, which causes low solubility in common organic solvents, hydrophobicity, low wettability, and difficulty in curing or crosslinking.

Insertion of a polar functional group on the polymer backbone is expected to overcome some of these drawbacks and allow their utilization in applications that require hydrophilic character. Two main approaches have been traditionally used for functionalizing fluoropolymers; the first involves copolymerization of fluoro-olefins with functional monomers (mostly non-fluorinated), and the second involves post-chemical modification on a fluoropolymer backbone. The disadvantage of using the first approach resides in the relatively low content of the functional groups when using functionalized fluorinated monomers and a decrease in the overall polymer performance when utilizing a hydrogenated functional monomer, due to the presence of C—H bonds instead of C—F bonds. As for the second approach, since only a few reagents can react with fluoropolymers due to their inertness, post-chemical modification is very hard to achieve. Thus, low functional group content is also obtained in this approach. Attempts to graft functional polymers on the main backbone of fluoropolymers have also been reported but also resulted in low content of functional groups.

Regarding homopolymerization of functional fluorinated monomers, the lack of reactivity of many of them is still left unclear. Most attempts have resulted in no reaction or in obtaining oligomers.

Ameduri et al [1,2] studied the radical copolymerization kinetics of VDF with α,α,β-trifluoroacrylate (MTFA). The reactivity ratios of VDF and MTFA in the copolymerization were determined to be 0.3±0.03 and 0, respectively, indicating that an alternating structure was obtained. In the same study, two additional experiments were performed with different monomer compositions in the feed, to achieve high monomer conversion along with high functional group composition. Although high conversions were achieved, rather low functional monomer compositions were detected (3% and 8%) in the final copolymer. It was summarized that in an effort to increase functionalization via MTFA content, an increase in the MTFA molar concentration caused (1) a decrease in the copolymer yield (from 91% to 53%), (2) a decrease in MTFA conversion (from 75% to 70%), and (3) a decrease in VDF conversion (from 92% to 50%), all contributing to the inability to increase the functionalization of the polymer. By increasing the MTFA molar concentration in the feed, the molecular weights of the copolymers produced were relatively the same (32,000 and 35,600 g/mol), suggesting that an increase in MTFA amounts could not yield high molecular weight products.

### BACKGROUND PUBLICATIONS

[1] Souzy, R.; Guiot, J.; Ameduri, B.; Boutevin, B.; Paleta, O. Macromolecules 2003, 36, 9390-9395.
[2] Souzy, R.; Boutevin, B.; Ameduri, B. Macromolecules 2012, 45, 3145-3160.

### GENERAL DESCRIPTION

The inventors of the invention disclosed herein have developed novel processes for the preparation of high molecular weight and highly functional poly(VDF-co-alkyl-TFA) copolymers utilizing vinylidene fluoride (VDF) and alkyl trifluoroacrylate (alkyl TFA), such as methyl trifluoroacrylate (MTFA). Copolymers prepared according to processes of the invention have exhibited excellent stability and enhanced overall solubility, by that overcoming some of the main drawbacks of fluoropolymers. By enhancing the copolymer solubility, easier modifications and functional group transformations could be achieved.

In most general terms, copolymerization of VDF and alkyl TFA, such as MTFA, was achieved via radical polymerization as well as by emulsion polymerization in absence of a fluorinated surfactant. The use of water as a reaction medium provided a safe, inexpensive, nonflammable, nontoxic and relatively odorless process; thereby rendering the process environmentally friendly. Other advantages include the affordability of high scale production, production of high molecular weight products, and efficient control over the properties of the polymers produced.

Copolymers of the invention may be generally represented by the structure:

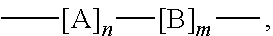

wherein
   A represents a unit derived from vinylidene fluoride (VDF),
   n is an integer representing the number of VDF units in the copolymer,
   B represents unit derived from alkyl trifluoroacrylate (alkyl-TFA), and
   m is an integer representing the number of alkyl-TFA units in the co-polymer.

Each of ‘-’ designates a chemical bond, typically a covalent bond, and wherein the end ‘-’ bonds designate possible repetitions or end functionalities, as further disclosed herein, and as customary in the field.

The order of A and B units in the copolymer may be random or may be distributed in blocks, provided that the number of each of the A and B units is as disclosed herein. A copolymer of structure -[A]n-[B]m- may thus be further presented as a copolymer of the structure -[A]-[B]-[A]-, -[B]-[A]-[B]-, -[A]-[A]-[B]-[A], -[B]-[A]-[A]-[B]-, -[A]-[A]-[A]-[A]-[B]- and so on, provided that the total number of A units and the total number of B units in the polymer is as defined.

As disclosed herein, a functionality derived from chemical modification of unit B (derived from the alkyl-TFA), in a copolymer of the invention, may be exchanged or modified to thereby lead to copolymers wherein the B units may be different along the copolymer chain. In such cases, and as further disclosed herein, a copolymer of the invention may comprise two or more different B units. Thus, in reference to the exemplary copolymers mentioned above, copolymers of the invention may be in a form of -[A]-[B]-[A]-[B′], -[B′]-[A]-[B]-, -[A]-[A]-[B]-[A], -[B]-[A]-[A]-[B′]-, -[A]-[B′]-[A]-[A]-[B]- and so on, wherein units B and B′ differ in a substituent group R or R″ or R′″, as further defined herein.

More specifically, in a copolymer of structure -[A]ₙ-[B]ₘ-, [A] represents a unit —[CH₂—CF₂]— and [B] represents a unit —[CF₂—CFR]—, and thus a co-polymer of the invention may be represented by a general structure (I):

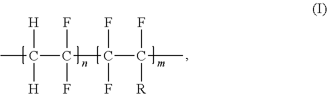

as defined herein.

In a first of its aspects, the invention provides a copolymer of structure -[A]ₙ-[B]ₘ, as defined above.

In another aspect, the invention provides a copolymer of structure (I):

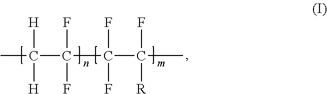

wherein
R is an atom or a group of atoms, excluding F (or not comprising F);
n is an integer between 50 and 2,000; and
m is an integer between 50 and 1,500.

In some embodiments, R is an alkyl ester of the form —CO₂—C₁-C₁₀alkyl, wherein variant R is derived from the alkyl-TFA used, e.g., —CO₂CH₃, and the copolymer is a high molecular weight and highly functionalized copolymer, as disclosed herein.

In some embodiments, R is —CO₂CH₃ or is different from —CO₂CH₃.

In some embodiments, R is derived from a chemical modification of the ester group in a compound wherein R is an alkyl ester, and thus may be further selected from halogens, alkyls, alkylenes, alkenyl, alkenyls, alkynyl, alkynyls, aromatic groups and moieties (including aryls, arylenes, heteroaryls and heteroarylenes), cycloalkyls, heterocycloalkyls, aralkyls, aralkylenes, haloalkyls, haloalkylenes, amines, hydroxides, thiols, sulfinyls, sulfonyls, amides, ethers, carboxylic acids, esters, ketones, alkoxys, oxiranes, phosphate esters, thiophosphate esters, dithiophosphate, phosphoric acid, alkyl phosphate, aldehydes, anhydrides, alpha-beta unsaturated groups, sulfoxides, sulfones, and others.

In some embodiments, R is an atom or a group of atoms selected from halides (Br, I or Cl, the halide is not F), —OH, —SH, —NR₁R₂R₃, —CO₂H, —CO₂R′, —CONR₁R₂R₃, —C₁-C₁₀alkylene-OH, —C₁-C₁₀alkylene-SH, —C₁-C₁₀alkylene-NR₁R₂R₃, —OR₄, —SO₄, —S(O)—, —SO₂—, —C₁-C₁₀alkylene-OR₄, —C₁-C₁₀alkylene-SR₄, —C₁-C₁₀alkyl, —C₁-C₁₀alkylene, —C₂-C₁₀alkenyl, —C₂-C₁₀alkenylene, —C₂-C₁₀alkynyl, —C₂-C₁₀alkynylene, —C₃-C₁₀carbocyclic, —C₂-C₁₀heterocyclic, —C₆-C₁₀aryl, —C₆-C₁₀arylene, —C₂-C₁₀heteroaryl, —C₂-C₁₀-heteroarylene, —C₁-C₁₀alkylene-C₆-C₁₀aryl, —C₁-C₁₀alkylene-C₆-C₁₀arylene, —C₆-C₁₀arylene-C₁-C₁₀alkyl, —C₁-C₁₀alkylene-SO₃H, —C₆-C₁₀arylene-SO₃H, carbohydrate segments, and others;
each of R₁, R₂, and R₃, independently of the other, as used in groups —NR₁R₂R₃, —CONR₁R₂R₃, and —C₁-C₁₀NR₁R₂R₃, independently, may be a substituted or unsubstituted, linear or cyclic —C₁-C₆alkyl, —C₂-C₆alkylene, —C₂-C₆alkenyl, —C₂-C₆alkenylene, —C₂-C₆alkynyl, —C₂-C₆alkynylene, —C₆-C₁₀aryl, —C₆-C₁₀arylene, —C₃-C₁₀heteroaryl or —C₃-C₁₀heteroarylene groups;
R′ may be similarly selected amongst substituted or unsubstituted, linear or cyclic —C₁-C₅alkyl (in some embodiments —C₁-C₁₀alkyl), —C₂-C₅alkylene, —C₂-C₅alkenyl, —C₂-C₅alkenylene, —C₂-C₅alkynyl, —C₂-C₅alkynylene, —C₆-C₁₀aryl, —C₆-C₁₀arylene, —C₃-C₁₀heteroaryl or —C₃-C₁₀heteroarylene groups; and
R₄ as used in groups such as —OR₄, —C₁-C₁₀OR₄, and —C₁-C₁₀SR₄, independently, may be selected from substituted or unsubstituted, linear or cyclic —C₁-C₅alkyl, —C₂-C₅alkylene, —C₂-C₅alkenyl, —C₂-C₅alkenylene, —C₂-C₅alkynyl, —C₂-C₅alkynylene, —C₆-C₁₀aryl, —C₆-C₁₀arylene, —C₃-C₁₀heteroaryl or —C₃-C₁₀heteroarylene groups.

As used herein, the terms alkyl, alkenyl and alkynyl refer to carbon chains containing a number of atoms, typically between 1 and 20 carbon atoms, or as specified, e.g., 1 2, 5 or 10 that are straight or branched. The expression “—C₁-C₅alkyl” indicates a carbon chain comprising between 1 and 5 carbon atoms, inclusive, which is free of double and triple bonds. Similarly, —C₁-C₁₀alkyl will include between 1 and 10 carbon atoms, inclusive.

Alkenyls and alkynyls will contain at least 2 carbon atoms and 1 or more double or triple bonds, respectively.

Exemplary alkyl, alkenyl and alkynyl groups herein include, but are not limited to, methyl, ethyl, propyl, isopropyl, isobutyl, n-butyl, sec-butyl, tert-butyl, iso-hexyl, allyl (propenyl) and propargyl (propynyl).

As used herein, “cycloalkyl” refers to a saturated mono- or multi-cyclic ring system, in certain embodiments of 3 to 10 carbon atoms, in other embodiments of 3 to 6 carbon atoms, which may be a fused ring system, a multiring system or a spiro ring system. “Heterocycloalkyls” or “heterocyclic” refers to mono- or multi-cyclic ring system, in certain embodiments of 2 to 10 carbon atoms, in other embodiments of 2 to 6 carbon atoms and 1 or more heteroatom selected from nitrogen, oxygen or sulfur. Such heterocyclic compounds are not regraded aromatic and may contain one or more inner cycle double bond.

As used herein, “aryl” refers to aromatic monocyclic or multicyclic groups containing from 6 to 10 carbon atoms. Aryl groups include but are not limited to groups such as unsubstituted or substituted fluorenyl, unsubstituted or substituted phenyl, and unsubstituted or substituted naphthyl, which may be further fused to another same or different ring or ring system.

As used herein, “heteroaryl” refers to a monocyclic or multicyclic aromatic ring system of 3 to 10 carbon atoms and 1 to 3 heteroatoms, selected from nitrogen, oxygen or sulfur. The heteroaryl group may be optionally fused to a benzene ring. Heteroaryl groups include, but are not limited to, furyl, imidazolyl, pyrimidinyl, tetrazolyl, thienyl, pyridyl, pyrrolyl, thiazolyl, isothiazolyl, oxazolyl, isoxazolyl, triazolyl, quinolinyl and isoquinolinyl.

The groups halogens, alkyls, alkylenes, alkenyl, alkenyls, alkynyl, alkynyls, aromatic groups and moieties (including aryls, arylenes, heteroaryls and heteroarylenes), cycloalkyls, aralkyls, aralkylenes, haloalkyls, haloalkylenes, amines, hydroxides, thiols, sulfinyls, sulfonyls, amides, ethers, carboxylic acids, esters, ketones, and alkoxys have the meaning acceptable in the art.

Any of the groups defining a variation of group R may or may not be substituted. Substitution may be by H or by any other atom or group of atoms. Substitution may be with one or more substituents, in some embodiments one, two, three or four substituents.

Acidic and basic groups such as carboxylic acid, alcohols and amines may be presented in their acid or base forms, as neutral or charged compounds. In some embodiments, the copolymers are provided as neutral compounds. In other embodiments, they are provided as charged (or salt) forms, wherein at least one of the acid or base functionalities is provided with a suitable counterion. The counterion may be organic or inorganic or comprising or consisting at least one metal ions.

In some embodiments, R is an atom or a group of atoms which may be derived from a single or multistep chemical manipulation of poly(VDF-co-alkyl-TFA), namely a compound of structure (I) wherein R is an alkyl ester of the form —CO₂-C₁-C₁₀alkyl, as defied herein, wherein the alkyl may be a methyl group, providing poly(VDF-co-MTFA).

In some embodiments, the nature of R is derived from reduction of the ester group.

In some embodiments, the compound of structure (I) is a compound having structure (II):

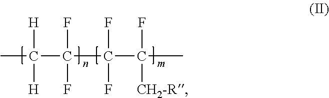

wherein
R″ is selected from halides (Br, I or Cl, excluding F), —OH, —SH, —NR₁R₂R₃, —CO₂H, —CO₂R′, —CONR₁R₂R₃, —C₁-C₁₀alkylene-OH, —C₁-C₁₀alkylene-SH, —C₁-C₁₀alkylene-NR₁R₂R₃, —OR₄, —SO₄, —S(O)—, —SO₂—, —C₁-C₁₀alkylene-OR₄, —C₁-C₁₀alkylene-SR₄, —C₁-C₁₀alkyl, —C₁-C₁₀alkylene, —C₂-C₁₀alkenyl, —C₂-C₁₀alkenylene, —C₂-C₁₀alkynyl, —C₂-C₁₀alkynylene, —C₃-C₁₀carbocyclic, —C₂-C₁₀heterocyclic, —C₆-C₁₀aryl, —C₆-C₁₀arylene, —C₂-C₁₀heteroaryl, —C₂-C₁₀-heteroarylene, —C₁-C₁₀alkylene-C₆-C₁₀aryl, —C₁-C₁₀alkylene-C₆-C₁₀arylene, —C₆-C₁₀arylene-C₁-C₁₀alkyl, —C₁-C₁₀alkylene-SO₃H, —C₆-C₁₀arylene-SO₃H, carbohydrate segments, and others, and wherein each of R₁, R₂, R₃, R₄, n and m is as defined above.

In a polymer of structure (I) and/or a polymer of structure (II), each of variants R and R″, respectively, may be the same along the polymer chain or may be varied along the polymer chain. For example, a copolymer of structure (II) may be of the structure (III):

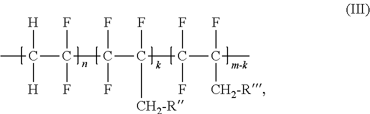

wherein
each of R″ and R′″ is same or different and, independently of the other, may be selected from halides (Br, I or Cl, excluding F), —OH, —SH, —NR₁R₂R₃, —CO₂H, —CO₂R′, —CONR₁R₂R₃, —C₁-C₁₀alkylene-OH, —C₁-C₁₀alkylene-SH, —C₁-C₁₀alkylene-NR₁R₂R₃, —OR₄, —SO₄, —S(O)—, —SO₂—, —C₁-C₁₀alkylene-OR₄, —C₁-C₁₀alkylene-SR₄, —C₁-C₁₀alkyl, —C₁-C₁₀alkylene, —C₂-C₁₀alkenyl, —C₂-C₁₀alkenylene, —C₂-C₁₀alkynyl, —C₂-C₁₀alkynylene, —C₃-C₁₀carbocyclic, —C₂-C₁₀heterocyclic, —C₆-C₁₀aryl, —C₆-C₁₀arylene, —C₂-C₁₀heteroaryl, —C₂-C₁₀-heteroarylene, —C₁-C₁₀alkylene-C₆-C₁₀aryl, —C₁-C₁₀alkylene-C₆-C₁₀arylene, —C₆-C₁₀arylene-C₁-C₁₀alkyl, —C₁-C₁₀alkylene-SO₃H, —C₆-C₁₀arylene-SO₃H, carbohydrate segments, and others, and wherein each of R₁, R₂, R₃, R₄, n and m is as defined above and wherein k is an integer being equal or smaller than m (namely being between 50 and 1500, yet smaller than or equal to the value of m).

In some embodiments, each of R″ and R′″ is different.

In some embodiments, the unit [CF₂CF(CH₂R″)] may be directly associated to a unit [CF₂CF(CH₂R′″)] or may be associated via a unit [CH₂F₂].

In some embodiments, the copolymer is a random polymer. In other embodiments, the copolymer is an alternating structure. Each of the forms is identifiable by such spectrometric techniques as F-NMR.

In some embodiments, compounds of structure (I) or (II) or (III) have a molecular weight (MW) ranging between 30 and 250 KDa. In some embodiments, the MW is between 35 and 250 KDa, or between 40 and 250, 45 and 250, 50 and 250, 55 and 250, 60 and 250, 70 and 250, 80 and 250, 90 and 250, or 100 and 250 Kda.

In some embodiments, compounds of structure (I), (II) or (III) are highly functionalized copolymers having a degree of functionalization of about 50%; namely at least 50% of the polymer units are derived from alkyl-TFA, e.g., MTFA (each bearing same or different R group). In some embodiments, the degree of functionalization is about or at least 50%; namely 50% or more of the repeating units are functionalized. In some embodiments, the degree of functionalization is up to or about 50%.

The invention further provides a high molecular weight and highly functionalized copolymer of methyl-trifluoroacrylate (MTFA) and vinylidene difluoride (i.e., 1,1-difluoroethylene, VDF), as defined herein, e.g., having a MW between 30 and 250 KDa, as selected herein, and a degree of functionalization of at least 50%, as defined herein.

The terminal groups of a copolymer of the invention may vary and may depend on the process for its preparation. The terminal groups may additionally be activated and replaced by any other functionality following known chemical modifications. Generally speaking, the terminal groups of a copolymer of the invention may be selected amongst sulfonic acid groups (which may be obtained in an emulsion polymerization process as disclosed herein), ether groups, alkyl groups, aryl groups and others. In some cases, the terminal groups may be selected amongst alkyls, alkylenes, alkenyl, alkenyls, alkynyl, alkynyls, aromatic groups and moieties (including aryls, arylenes, heteroaryls and heteroarylenes), cycloalkyls, heterocycloalkyls, aralkyls, aralkylenes, haloalkyls, haloalkylenes, amines, hydroxides, thiols, sulfinyls, sulfonyls, amides, ethers, carboxylic acids, esters, ketones, alkoxys, oxiranes, phosphate esters, thiophosphate esters, dithiophosphate, phosphoric acid, alkyl phosphate, aldehydes, anhydrides, alpha-beta unsaturated groups, sulfoxides, sulfones, and others.

Two synthetic methods have been utilized for successfully achieving copolymerization of VDF and alkyl-TFA, such as MTFA. Using a modified radical polymerization, highly functionalized fluorinated copolymers comprising at least 36% functional groups with high molecular weights, around 77 KDa, have been prepared. Copolymers with even higher percentages of functional groups, reaching 40% and higher, and with significantly higher molecular weights reaching as high as between 180 and 250 KDa, were produced via emulsion polymerization. As demonstrated herein, non-fluorinated surfactants were used.

Thus, in another aspect, there is provided a process for manufacturing a copolymer of alkyl-TFA and VDF (being poly(VDF-co-alkyl-TFA)), the process comprising:
in an aqueous medium free of a fluorinated surfactant, reacting VDF and alkyl-TFA under conditions permitting copolymerization.

In some embodiments, the process comprises forming an emulsion of alkyl-TFA in water. In some embodiments, the emulsion further comprises at least one non-fluorinated surfactant. The non-fluorinated surfactant may be selected amongst nonionic, anionic, cationic or amphoteric surfactants. In some embodiments, the surfactant is an anionic surfactant such as sodium dodecyl sulfate (SDS), SLS (sodium lauryl sulfate), ALS (ammonium lauryl sulfate) or any metal alklyethersulfate.

In some embodiments, the anionic surfactant is selected amongst soaps, alkylbenzene sulfonates, alkyl sulfonates, alkyl sulfonates, polyoxyethylene fatty alcohol phosphates ether, alkyl alcohol amide, alkyl sulfonic acid acetamide, alkyl sulfates, salts of fluorinated fatty acids, silicones, α-olefin sulfonate, alkyl succinate sulfonate salts, amino alcohol alkylbenzene sulfonates, fatty alcohol sulfates, polyoxyethylene fatty alcohol ether sulfates, naphthenates, alkylphenol sulfonate and polyoxyethylene monolaurate.

In some embodiments, the alkyl-TFA emulsion is treated with gaseous VDF under pressure.

In some embodiments, the copolymer is formed within a reactor, e.g., a pressurized reactor.

The conditions permitting copolymerization comprise increased pressure and high temperatures. The pressure applied to the reaction mixture, e.g., the reactor in which the copolymer is formed, may be between 4 and 30 bars. In some embodiments, the pressure may be between 4 and 10, 10 and 15, 10 and 30, or 15 and 30 bars. The reaction may be carried out at a temperature above room temperature. In some embodiments, the temperature is between 5° and 150° C. In some embodiments, the temperature is or around 100° C.

In some embodiments, the reaction may be carried out in a reactor under a pressure between 4 and 15 bars and at a temperature between 5° and 150° C.

The invention further provides a process for manufacturing a high molecular weight and highly functionalized copolymer of alkyl-TFA and VDF (being poly(VDF-co-alkyl-TFA)), process comprising:-reacting alkyl-TFA and VDF in an organic solvent, such as acetonitrile, dimethylformamide (DMF), dimethylacetamide (DMAc) and dimethyl sulfoxide (DMSO), in presence of at least one free radical initiator, under conditions permitting formation of the high molecular weight and highly functionalized copolymer.

In some embodiments, the reaction is carried out in a reactor, e.g., a pressurized reactor.

In some embodiments, the reaction is carried out under increased pressure and temperature.

The at least one free radical initiator may be any such material known in the art. In some embodiments, the free radical initiator is an organic peroxide, hydroperoxide or an azo-based compound. Non-limiting examples include tert-butyl peroxypivalate (TBPP), benzoyl peroxide (BPO), di-tert-butyl peroxide (DTBP), tert-amyl peroxypivalate, di-tertiary-butyl peroxide (DTBD), tert-amyl peroxyacetate, tert-butyl peroxyacetate, dicumyl peroxide, cumene hydroperoxide, 2,2′-azobis(isobutyronitrile) (AIBN), 2-methylbutyronitrile (AMBN), dimethyl 2,2′-azobis(2-methylpropionate), and (4,4′-Azobis(4-cyanopentanoic acid) (ACVA).

The conditions permitting formation of the high molecular weight and highly functionalized copolymer comprise increased pressure and high temperatures. The pressure applied to the reaction mixture, e.g., the reactor in which the copolymer is formed, may be between 9 and 15 bars. In some embodiments, the pressure may be between 9 and 12 bars. The reaction may be carried out at a temperature above room temperature. In some embodiments, the temperature may be between 10° and 150° C. In some embodiments, the temperature may be between 100 and 140 or between 10° and 135° C. In some embodiments, the temperature may be 134° C.

As used herein, the copolymer of alkyl-TFA and VDF is a copolymer of the structure (I), wherein R is —CO₂C₁-C₁₀-alkyl. In some embodiments, the alkyl-TFA is a —C₁-C₁₀alkyl-TFA, wherein the alkyl is such groups as methyl ethyl, propyl, butyl, tert-butyl, pentyl, hexyl, heptyl, octyl, nonyl decyl and other alkyls having between 1 and 10 carbon atoms. In some embodiments, the copolymer is a copolymer of MTFA and VDF having the structure:

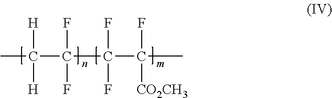

The high molecular weight and highly functionalized copolymer of MTFA and VDF is the copolymer of structure (I), wherein R is —CO₂CH₃, being poly(VDF-co-MTFA), wherein n is between 1000 and 2,000 and m is between 500 and 1,500. In some embodiments, n is between 1,000 and 1300 or between 1,000 and 1,200 or between 1,000 and 1,100. In some embodiments, m is between 500 and 1,300, 500 and 1,200, 500 and 1,100, 500 and 1000, 500 and 900, 500 and 800 or between 100 and 700.

Putting it differently, the high molecular weight and highly functionalized copolymer (III) has a molecular weight (MW) ranging between 30 and 250 KDa, or between 35 and 250 KDa, or between 40 and 250, or between 45 and 250, or between 50 and 250, or between 55 and 250, or between 60 and 250, or between 70 and 250, or between 80 and 250, or between 90 and 250, or between 100 and 250 Kda and/or a degree of functionalization of about 50% or at least 50%.

In a reaction involving radical polymerization, the initial molar ratio of the monomers, reaction time and applied VDF pressure, the composition of the copolymer and its molecular weight have been examined. It was found that against the teachings of the prior art increasing the alkyl-TFA, e.g., MTFA, molar concentration in the feed resulted in an increase in its composition in the produced copolymer. Thus, according to some embodiments, a molar ratio alkyl-TFA:VDF or MTFA:VDF may range from 1:10 to 10:1. In some embodiments, the ratio is 1:10, 1:9, 1:8, 1:7, 1:6, 1:5, 1:4, 1:3, 1:2, 1:1, 2:1, 3:1, 4:1, 5:1, 6:1, 7:1, 8:1, 9:1 or 10:1.

In all reactions, the results have been found to be reproducible by means of copolymer composition and copolymer yield. Amazingly, the reactions to produce the copolymer were found to be scalable, and the same copolymer composition has been achieved.

Post modifications of the ester group in the copolymer poly(VDF-co-alkyl-TFA), wherein the alkyl may be a methyl group or any other alkyl as defined, to a variety of different functional groups such as carboxylic acid, alcohol, amide, and benzenesulfonic acid, as well as to any of the functionalities defining group R in a copolymer of structure (I), were obtained successfully and their structures have been investigated and verified. The obtained modified copolymers exhibited different properties, which makes them suitable for different applications, e.g., membranes. Copolymers of the invention have demonstrated film forming properties and porosity that may be modified to be utilized in manufacturing membranes, matrix materials and coatings.

In another aspect, the invention contemplates use of a co-polymer of structure (I) or (II) or (III) or (IV) as a film forming material.

The invention further provides use of a copolymer having the structure (I) or (II) or (III) or (IV) for manufacturing a film or a porous sheet or a membrane.

Moreover, all functionalized copolymers except poly(VDF-co-TFAcA), were found to dissolve in common organic solvents. Remarkably, poly(VDF-co-TFAA) which has a carboxylic acid (or the salt form thereof) group on the main backbone, was found to be water-soluble. Thus, the invention further provides compositions or formulations comprising a copolymer of the invention and a liquid medium selected from an organic solvent (such as THF, acetone, chloroform, methylene chloride, acetone, ethanol, methanol, ether and others) and aqueous media.

An important building block manufactured by processes disclosed herein is the alcohol derivative encompassed by structure (I), wherein R is —CH₂—OH, or by structure (II), wherein R is —OH. The alcohol derivative may be obtained by reduction of the ester in a compound of structure (IV). The structure of the alcohol is provided as structure (V):

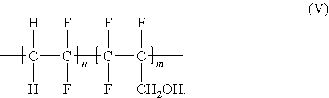

The alcohol derivative (V) as well as many of the other derivatives encompassed by structure (I) open the door for a multitude of synthetic pathways for constructing functional copolymers of a variety of structures and attributes. Further modifications to a variety of functional groups, can be performed via chemical modifications, due to the enhanced solubility of these polymers.

The thermal properties of these copolymers were also investigated, showing relatively high thermal stability with dependence to the type of functional group. Among the functionalized copolymers, the results showed that poly(VDF-co-MTFA) had the lowest Tg and the highest thermal stability. Thus, a copolymer poly(VDF-co-MTFA), being a compound of structure (I), wherein R is CO₂CH₃, or high molecular weight and/or high functionalization forms thereof, as defined may be reacted to produce a derivative thereof, said derivative being a compound of structure (Ta):

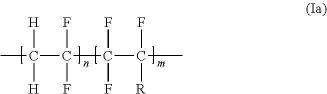

wherein each of n and m are as defined for structure (I) and wherein R is an atom or a group of atoms being different from a methyl ester and selected from halides (Br, I or Cl), —OH, —SH, —NR₁R₂R₃, —CO₂H, —CO₂R′ (wherein R′ is different from —CH₃), —CONR₁R₂R₃, —C₁-C₁₀OH, —C₁-C₁₀SH, —C₁-C₁₀NR₁R₂R₃, —OR₄, —SO₄, —S(O)—, —SO₂—, —C₁-C₁₀OR₄, —C₁-C₁₀SR₄, —C₁-C₁₀alkyl, —C₁-C₁₀alkylene, —C₂-C₁₀alkenyl, —C₂-C₁₀alkenylene, —C₂-C₁₀alkynyl, —C₂-C₁₀alkynylene, —C₃-C₁₀carbocyclic, —C₂-C₁₀heterocyclic, —C₆-C₁₀aryl, —C₆-C₁₀arylene, —C₂-C₁₀heteroaryl, —C₂-C₁₀-heteroarylene, —C₁-C₁₀alkylene-C₆-C₁₀aryl, —C₁-C₁₀alkylene-C₆-C₁₀arylene, —C₆-C₁₀arylene-C₁-C₁₀alkyl, —C₁-C₁₀alkylene-SO₃H, —C₆-C₁₀arylene-SO₃H, carbohydrate segments, and others.

In some embodiments, the copolymer is a compound wherein R is —CO₂H, —CH₂OH, —CONH₂, CH₂O-p-phenyl-SO₃H and others.

In some embodiments, a process of the invention for manufacturing a copolymer as defined, further comprises a step of chemically manipulating or modifying the ester group in a compound of structure (IV) to produce a compound of the structure (I), wherein R is different from CO₂CH₃. The copolymer bearing the ester group may or may not be a copolymer prepared by any of the processes of the invention. In some embodiments, the copolymer is a product of a process of the invention as disclosed herein.

The chemical manipulations or modification is any chemical reaction that can be used on a copolymer of the invention to convert the ester group into any of the groups encompassed by variant R defined for structure (Ia), or structure (I) excluding CO₂CH₃. Such chemical modifications may be or may comprise reduction, oxidation, addition reactions, elimination reactions, substitution reactions, pericyclic reactions, rearrangement reactions, catalytic reactions, photochemical reactions, acid-base reactions, coupling reactions, polymerization reactions, insertion reactions, ring-opening reactions, ring-closing reactions or any other chemical reaction known in the art.

The fluoropolymers of the invention may find applications in the field of membranes, adhesives, protective coatings, compatibilizers, lithium-ion batteries, etc., with dependence on the nature of the functional group. Thus, the invention further provides a formulation or composition comprising a copolymer of the invention for use in a method of preparing a copolymer-based product as defined above, e.g., membranes, adhesives, coatings, compatibilizers, etc. In some embodiments, the copolymer is the copolymer prepared by the free radical process or the emulsion process, or is a copolymer derivative of structure (I), (II), (III) or (Ia) or any of the specific derivatives disclosed herein.

The formulation or composition of the invention may be neat, namely comprise only the copolymer or may comprise at least one carrier such as water or an organic solvent or medium. The formulation or composition may also include additives, stabilizers and other components suitable for rendering the formulation or composition functional or suitable for use.

In some embodiments, the formulation or composition is configured for use as a matrix material, an adhesive material, as a coloring material, as a stabilizing material, as a protective material or coatings, as a compatibilizer, as a binder, an anticorrosion coating material, a gel electrolyte material, an ion exchange material, a swelling material, a pore former material, a surface active material, a composite material, a gel material, a conductive material, an isolating material, a membrane material either laminar or tubular or coaxial, a deicing material, as an anticorrosive material, or generally as an additive.

The copolymer may be used as is or in combination with one or more additional polymers or in a composite with one or more other materials.

The invention provides:

A copolymer represented by structure:

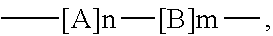

wherein
   A represents a unit derived from vinylidene fluoride (VDF),
   n is an integer representing a number of VDF units in the copolymer,
   B represents a unit derived from —C₁-C₁₀alkyl trifluoroacrylate (alkyl-TFA), and
   m is an integer representing a number of alkyl-TFA units in the co-polymer;
wherein the copolymer is obtained by emulsion polymerization.

In some cases, the —C₁-C₁₀alkyl trifluoroacrylate is selected from methyl, ethyl, propyl, butyl, pentyl, hexyl, heptyl, octyl, nonyl and decyltrifluoroacrylate.

In some cases, the alkyl-TFA is methyl-TFA (MTFA), and wherein the copolymer is poly(VDF-co-MTFA).

Also provided is a copolymer of poly(VDF-co-MTFA) having a molecular weight between 30 and 250 KDa and a degree of functionalization of about 50% or at least 50%.

In some cases, the copolymer having a structure (I):

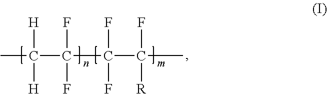

wherein
R is an atom or a group of atoms, excluding F;
n is an integer between 50 and 2,000; and
m is an integer between 50 and 1,500.

In some cases, R is —CO₂CH₃.

In some cases, R is selected from Br, I, Cl, —OH, —SH, —NR₁R₂R₃, —CO₂H, —CO₂R′, —CONR₁R₂R₃, —C₁-C₁₀alkylene-OH, —C₁-C₁₀alkylene-SH, —C₁-C₁₀alkylene-NR₁^{R}₂R₃, —OR₄, —SO₄, —S(O)—, —SO₂—, —C₁-C₁₀alkylene-OR₄, —C₁-C₁₀alkylene-SR₄, —C₁-C₁₀alkyl, —C₁-C₁₀alkylene, —C₂-C₁₀alkenyl, —C₂-C₁₀alkenylene, —C₂-C₁₀alkynyl, —C₂-C₁₀alkynylene, —C₃-C₁₀carbocyclic, —C₂-C₁₀heterocyclic, —C₆-C₁₀aryl, —C₆-C₁₀arylene, —C₂-C₁₀heteroaryl, —C₂-C₁₀-heteroarylene, —C₁-C₁₀alkylene-C₆-C₁₀aryl, —C₁-C₁₀alkylene-C₆-C₁₀arylene, —C₆-C₁₀arylene-C₁-C₁₀alkyl, —C₁-C₁₀alkylene-SO₃H, —C₆-C₁₀arylene-SO₃H, and a carbohydrate segment, wherein
each of R₁, R₂, and R₃, independently of the other, is a substituted or unsubstituted, linear or cyclic —C₁-C₆alkyl, —C₂-C₆alkylene, —C₂-C₆alkenyl, —C₂-C₆alkenylene, —C₂-C₆alkynyl, —C₂-C₆alkynylene, —C₆-C₁₀aryl, —C₆-C₁₀arylene, —C₃-C₁₀heteroaryl or —C₃-C₁₀heteroarylene groups;
R′ is selected amongst substituted or unsubstituted linear or cyclic —C₁-C₅alkyl, —C₂-C₅alkylene, —C₂-C₅alkenyl, —C₂-C₅alkenylene, —C₂-C₅alkynyl, —C₂-C₅alkynylene, —C₆-C₁₀aryl, —C₆-C₁₀arylene, —C₃-C₁₀heteroaryl and —C₃-C₁₀heteroarylene groups; and wherein
R₄ is selected from substituted or unsubstituted linear or cyclic —C₁-C₅alkyl, —C₂-C₅alkylene, —C₂-C₅alkenyl, —C₂-C₅alkenylene, —C₂-C₅alkynyl, —C₂-C₅alkynylene, —C₆-C₁₀aryl, —C₆-C₁₀arylene, —C₃-C₁₀heteroaryl and —C₃-C₁₀heteroarylene groups.

In some cases, the copolymer having structure (II):

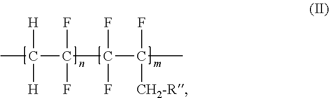

wherein
R″ is selected from Br, I, Cl, —OH, —SH, —NR₁R₂R₃, —CO₂H, —CO₂R′, —CONR₁R₂R₃, —C₁-C₁₀alkylene-OH, —C₁-C₁₀alkylene-SH, —C₁-C₁₀alkylene-NR₁R₂R₃, —OR₄, —SO₄, —S(O)—, —SO₂—, —C₁-C₁₀alkylene-OR₄, —C₁-C₁₀alkylene-SR₄, —C₁-C₁₀alkyl, —C₁-C₁₀alkylene, —C₂-C₁₀alkenyl, —C₂-C₁₀alkenylene, —C₂-C₁₀alkynyl, —C₂-C₁₀alkynylene, —C₃-C₁₀carbocyclic, —C₂-C₁₀heterocyclic, —C₆-C₁₀aryl, —C₆-C₁₀arylene, —C₂-C₁₀heteroaryl, —C₂-C₁₀-heteroarylene, —C₁-C₁₀alkylene-C₆-C₁₀aryl, —C₁-C₁₀alkylene-C₆-C₁₀arylene, —C₆-C₁₀arylene-C₁-C₁₀alkyl, —C₁-C₁₀alkylene-SO₃H, —C₆-C₁₀arylene-SO₃H, and a carbohydrate segment, and wherein each of R′, R₁, R₂, R₃, R₄, n and m is as defined herein.

In some cases, the copolymer having structure (III):

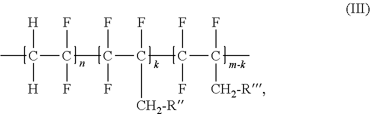

wherein
each of R″ and R′″, independently of the other, is selected from Br, I, Cl, —OH, —SH, —NR₁R₂R₃, —CO₂H, —CO₂R′, —CONR₁R₂R₃, —C₁-C₁₀alkylene-OH, —C₁-C₁₀alkylene-SH, —C₁-C₁₀alkylene-NR₁R₂R₃, —OR₄, —SO₄, —S(O)—, —SO₂—, —C₁-C₁₀alkylene-OR₄, —C₁-C₁₀alkylene-SR₄, —C₁-C₁₀alkyl, —C₁-C₁₀alkylene, —C₂-C₁₀alkenyl, —C₂-C₁₀alkenylene, —C₂-C₁₀alkynyl, —C₂-C₁₀alkynylene, —C₃-C₁₀carbocyclic, —C₂-C₁₀heterocyclic, —C₆-C₁₀aryl, —C₆-C₁₀arylene, —C₂-C₁₀heteroaryl, —C₂-C₁₀-heteroarylene, —C₁-C₁₀alkylene-C₆-C₁₀aryl, —C₁-C₁₀alkylene-C₆-C₁₀arylene, —C₆-C₁₀arylene-C₁-C₁₀alkyl, —C₁-C₁₀alkylene-SO₃H, —C₆-C₁₀arylene-SO₃H, and a carbohydrate segment;
each of R′, R₁, R₂, R₃, R₄, n and m is as defined herein; and wherein k is an integer equal or smaller than m, namely k is between zero and between 50 or 1,500, or is between 50 and 1,500.

In some cases, each of R″ and R′″ is different.

In some cases, R is —CO₂H, —CH₂OH, —CONH₂, or —CH₂O-p-phenyl-SO₃H.

In some cases, R″ is —OH or —O-p-phenyl-SO₃H.

In some cases, one or both of R″ and R′″ is —OH.

Further provided is a copolymer of structure (V):

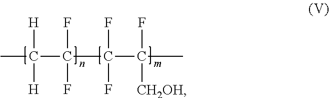

wherein each of n and m is as defined herein.

Also provided is a copolymer, wherein R is not a methyl ester.

Further provided is a high molecular weight and a highly functionalized copolymer of methyl-trifluoroacrylate (MTFA) and vinylidene difluoride having structure (IV) and a molecular weight between 30 and 250 KDa and a degree of functionalization of at least 50%:

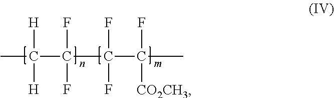

wherein each of n and m is as defined herein.

Further provided is a process for manufacturing a copolymer of alkyl-TFA and VDF (being poly(VDF-co-alkyl-TFA)), the process comprising:
in (i) an aqueous medium free of a fluorinated surfactant, or in (ii) an organic solvent, in presence of at least one free radical initiator, reacting VDF and alkyl-TFA under conditions permitting copolymerization of alkyl-TFA and VDF to obtain poly(VDF-co-alkyl-TFA).

In some cases, the alkyl-TFA is methyl-TFA (MTFA).

In some cases, the process is for manufacturing a copolymer of alkyl-TFA and VDF (being poly(VDF-co-alkyl-TFA)), the process comprising:
in an aqueous medium free of a fluorinated surfactant, reacting VDF and alkyl-TFA under conditions permitting copolymerization of alkyl-TFA and VDF to obtain poly(VDF-co-alkyl-TFA).

In some cases, the process comprising forming an emulsion of alkyl-TFA in water.

In some cases, the emulsion comprises at least one non-fluorinated surfactant.

In some cases, the non-fluorinated surfactant is selected amongst nonionic, anionic, cationic or amphoteric surfactants.

In some cases, the alkyl-TFA emulsion is treated with gaseous VDF under pressure.

In some cases, the copolymer is formed within a pressurized reactor.

In some cases, the conditions permitting copolymerization comprise an applied pressure of between 4 and 30 bars and a temperature above room temperature (23-30° C.).

In some cases, the temperature is between 5° and 150° C.

In some cases, the process comprising isolating the copolymer.

In some cases, the copolymer is further reacted to afford a copolymer of structure (I):

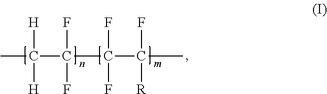

wherein
R is an atom or a group of atoms, excluding F;
n is an integer between 50 and 2,000;
m is an integer between 50 and 1,500; and wherein
R is different from —CO₂CH₃.

In some cases, R is —CH₂OH.

In some cases, the process is for forming a copolymer according to the invention.

In some cases, the process is for manufacturing a high molecular weight and highly functionalized copolymer of alkyl-TFA and VDF (being poly(VDF-co-alkyl-TFA)), the process comprising:
reacting alkyl-TFA and VDF in an organic solvent, in presence of at least one free radical initiator, under conditions permitting formation of the high molecular weight and highly functionalized poly(VDF-co-alkyl-TFA copolymer.

In some cases, the organic solvent is selected from acetonitrile, dimethylformamide (DMF), dimethylacetamide (DMAc) and dimethyl sulfoxide (DMSO).

In some cases, the process is carried out in a pressurized reactor.

In some cases, the at least one free radical initiator is selected from tert-butyl peroxypivalate (TBPP), benzoyl peroxide (BPO), di-tert-butyl peroxide (DTBP), tert-amyl peroxypivalate, di-tertiary-butyl peroxide (DTBD), tert-amyl peroxyacetate, tert-butyl peroxyacetate, dicumyl peroxide, cumene hydroperoxide, 2,2′-azobis(isobutyronitrile) (AIBN), 2-methylbutyronitrile (AMBN), dimethyl 2,2′-azobis(2-methylpropionate), and (4,4′-Azobis(4-cyanopentanoic acid) (ACVA).

In some cases, the process is carried out at a pressure of between 9 and 15 bars and at a temperature above room temperature.

In some cases, the temperature is between 10° and 150° C.

In some cases, the process comprising isolating the copolymer.

In some cases, the copolymer is further reacted to afford a copolymer of structure (I):

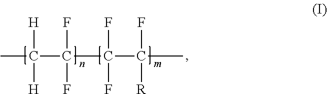

wherein
R is an atom or a group of atoms, excluding F;
n is an integer between 50 and 2,000;
m is an integer between 50 and 1,500; and wherein
R is different from —CO₂CH₃.

In some cases, R is —CH₂OH.

In some cases, the process is for forming a copolymer according to the invention.

In some cases, a molar ratio MTFA:VDF is from 1:10 to 10:1.

In some cases, the molar ratio is 1:10, 1:9, 1:8, 1:7, 1:6, 1:5, 1:4, 1:3, 1:2, 1:1, 2:1, 3:1, 4:1, 5:1, 6:1, 7:1, 8:1, 9:1 or 10:1.

In some cases, the process further comprising a step of transforming the ester group in the copolymer poly(VDF-co-MTFA) to a carboxylic acid, an alcohol, an amide, or a benzenesulfonic acid.

In some cases, the process further comprising a step of transforming the ester group in the copolymer poly(VDF-co-alkyl-TFA) to a compound of structure (I):

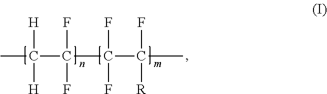

wherein
n is an integer between 50 and 2,000;
m is an integer between 50 and 1,500; and
R being different from the alkyl in said alkyl-TFA and is selected from Br, I, Cl, —OH, —SH, —NR₁R₂R₃, —CO₂H, —CO₂R′, —CONR₁R₂R₃, —C₁-C₁₀alkylene-OH, —C₁-C₁₀alkylene-SH, —C₁-C₁₀alkylene-NR₁R₂R₃, —OR₄, —SO₄, —S(O)—, —SO₂—, —C₁-C₁₀alkylene-OR₄, —C₁-C₁₀alkylene-SR₄, —C₁-C₁₀alkyl, —C₁-C₁₀alkylene, —C₂-C₁₀alkenyl, —C₂-C₁₀alkenylene, —C₂-C₁₀alkynyl, —C₂-C₁₀alkynylene, —C₃-C₁₀carbocyclic, —C₂-C₁₀heterocyclic, —C₆-C₁₀aryl, —C₆-C₁₀arylene, —C₂-C₁₀heteroaryl, —C₂-C₁₀-heteroarylene, —C₁-C₁₀alkylene-C₆-C₁₀aryl, —C₁-C₁₀alkylene-C₆-C₁₀arylene, —C₆-C₁₀arylene-C₁-C₁₀alkyl, —C₁-C₁₀alkylene-SO₃H, —C₆-C₁₀arylene-SO₃H, and a carbohydrate segment, wherein
each of R₁, R₂, and R₃, independently of the other, is a substituted or unsubstituted, linear or cyclic —C₁-C₆alkyl, —C₂-C₆alkylene, —C₂-C₆alkenyl, —C₂-C₆alkenylene, —C₂-C₆alkynyl, —C₂-C₆alkynylene, —C₆-C₁₀aryl, —C₆-C₁₀arylene, —C₃-C₁₀heteroaryl or —C₃-C₁₀heteroarylene groups;
R′ is selected amongst substituted or unsubstituted, linear or cyclic —C₁-C₅alkyl, —C₂-C₅alkylene, —C₂-C₅alkenyl, —C₂-C₅alkenylene, —C₂-C₅alkynyl, —C₂-C₅alkynylene, —C₆-C₁₀aryl, —C₆-C₁₀arylene, —C₃-C₁₀heteroaryl and —C₃-C₁₀heteroarylene groups; and wherein
R₄ is selected from substituted or unsubstituted, linear or cyclic —C₁-C₅alkyl, —C₂-C₅alkylene, —C₂-C₅alkenyl, —C₂-C₅alkenylene, —C₂-C₅alkynyl, —C₂-C₅alkynylene, —C₆-C₁₀aryl, —C₆-C₁₀arylene, —C₃-C₁₀heteroaryl and —C₃-C₁₀heteroarylene groups.

In some cases, the copolymer poly(VDF-co-MTFA) is transformed to a compound of structure (V):

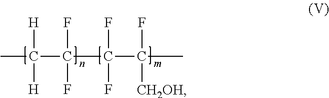

wherein each of n and m is as defined herein.

In some cases, R is —CO₂H, —CH₂OH, —CONH₂, or CH₂O-p-phenyl-SO₃H.

Also provided is an organic or an aqueous composition comprising a copolymer according to the invention.

In some cases, the composition comprises a compound of structure (I), wherein R is a methyl ester or a —CH₂OH.

Also provides is a use of a copolymer according to the invention as a matrix material, an adhesive material, a coloring material, a stabilizing material, a protective material, a coating material, a compatibilizer, a binder, anticorrosion coating material, a gel electrolyte material, an ion exchange material, a swelling material, a pore former material, a surface active material, a composite material, a gel material, a conductive material, an isolating material, a membrane material, a deicing material, or as an anticorrosive material.

Also provided is a use of a copolymer according to the invention as a film forming material, a porous sheet or a membrane.

An object is provided that is formed of a copolymer according to the invention.

In some cases, the object is a film or a polymer sheet or a membrane.

A material is provided which comprises or consists a copolymer according to the invention of that prepared according to a process of the invention, the material being selected from a matrix material, an adhesive material, a coloring material, a stabilizing material, a protective material, a coating material, a compatibilizer, a binder (for example in alkaline or acidic batteries), anticorrosion coating material, a gel electrolyte material, an ion exchange material, a swelling material, a pore former material, a surface active material, a composite material, a gel material, a conductive material, an isolating material, a membrane material, a deicing material, and an anticorrosive material.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 provides the Equation for calculation of copolymer yield by weight.

FIG. 2 provides a crude 19FNMR spectra of poly(VDF-co-MTFA) recorded in DMSO-d6.

FIG. 3 provides the Equation for calculation of MTFA conversion.

FIGS. 4A-B depict the reaction pathway for the synthesis of poly(VDF-co-MTFA). A) via conventional radical polymerization, B) via emulsion polymerization.

FIG. 5 depicts the Reaction pathways for the post modification of poly(VDF-co-MTFA).

FIG. 6 depicts the Mayo-Lewis copolymerization composition curve for poly(VDF-co-MTFA) copolymerization.

FIG. 7 provides the FT-IR analysis of poly(VDF-co-MTFA) copolymer.

FIG. 8 provides the FT-IR analysis of poly(VDF-co-TFAA) compared to poly(VDF-co-MTFA).

FIG. 9 provides the Dept-135 analysis of poly(VDF-co-MTFA) compared to poly(VDF-co-TFAA) recorded in DMSO-d6.

FIGS. 10A-B provide the Dept-135 analysis of (A) poly(VDF-co-MTFA) compared to (B) poly(VDF-co-TFA) recorded in DMSO-d6.

FIG. 11 provides the FT-IR analysis of poly(VDF-co-TFA) compared to poly(VDF-co-MTFA).

FIG. 12 provides the FT-IR analysis of poly(VDF-co-TFAcA) compared to poly(VDF-co-MTFA).

FIG. 13 provides the TGA-MS thermograms of the synthesized VDF based copolymers with different functional groups. Flow rate; 20° C./min, under argon flow.

FIG. 14 provides the TGA thermogram of poly(VDF-co-MTFA).

FIG. 15 provides1 the TGA and the first derivative thermograms of poly(VDF-co-TFA).

FIG. 16 provides the TGA thermogram of poly(VDF-co-TFAA).

FIG. 17 provides the TGA thermogram of poly(VDF-co-TFOBSA).

FIG. 18 provides the TGA thermogram of poly(VDF-co-TFAcA).

### DETAILED DESCRIPTION OF EMBODIMENTS

### Experimental

### 1.1 Materials

Methyl, 2,2,3 trifluoroacrylate (MTFA), and 1,1 difluoroethylene (VDF) was purchased from Matrix scientific. Tert-butyl peroxypivalate (TBPP) was purchased from Ochem incorporation. Lithium hydroxide (LiOH), Lithium borohydride in THF 2M (LiBH₄), Diisopropyl azodicarboxylate (DIAD), Triphenylphosphine (Ph₃P), 4-Hydroxybenzenesulfonic acid (HBSA), Ethyl acetoacetate (EAA), Diethylaminosulfur trifluoride (DAST), Ammonia in methanol 7N (NH₃ in MeOH), Tetrahydrofurane anhydrous (THF), Acetonitrile anhydrous (CH₃CN), Ethanol (EtOH), N-Methyl-2-pyrolidone anhydrous (NMP), Dimethyl sulfoxide (DMSO), Dimethylformamide (DMF), Potassium persulfate (KPS), Sodium dodecyl sulfate (SDS) were purchased from Sigma Aldrich and was used as received unless stated otherwise.

### 1.2 Characterization

The structures of all the copolymers were characterized and confirmed with nuclear magnetic resonance (NMR) and infrared spectroscopy. All ¹HNMR and ¹⁹FNMR spectra were recorded by using Avance 200 Bruker spectrometer. Dept135 and ¹³CNMR were recorded by using Avance III 600 Bruker spectrometer. Depending on the sample, deuterated DMSO, or CDCl₃ were used as solvents. IR measurements were conducted by using Bruker Platinum-ATR. Spectra were recorded in the range of 400 to 4000 cm⁻¹.

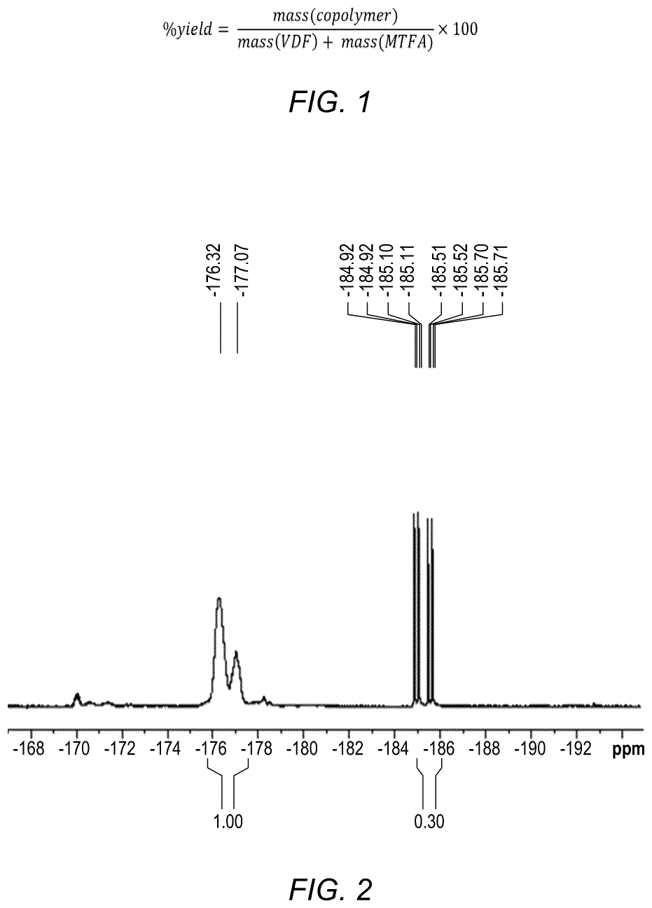

Conversion and yield. All polymerization reaction yields were calculated by weight according to the equation shown in FIG. 1.

Conversion of the functionalized monomer was determined according to the ¹⁹FNMR spectra of the crude product, by calculating the integration ratio between the peak of the unreacted monomer and the peak of the monomer in the copolymer, as shown in FIG. 2. Polymerization conditions: VDF/MTFA ratio 70/30, 1% mol TBPP in acetonitrile, VDF pressure of 20 bar, 134° C., 48 h

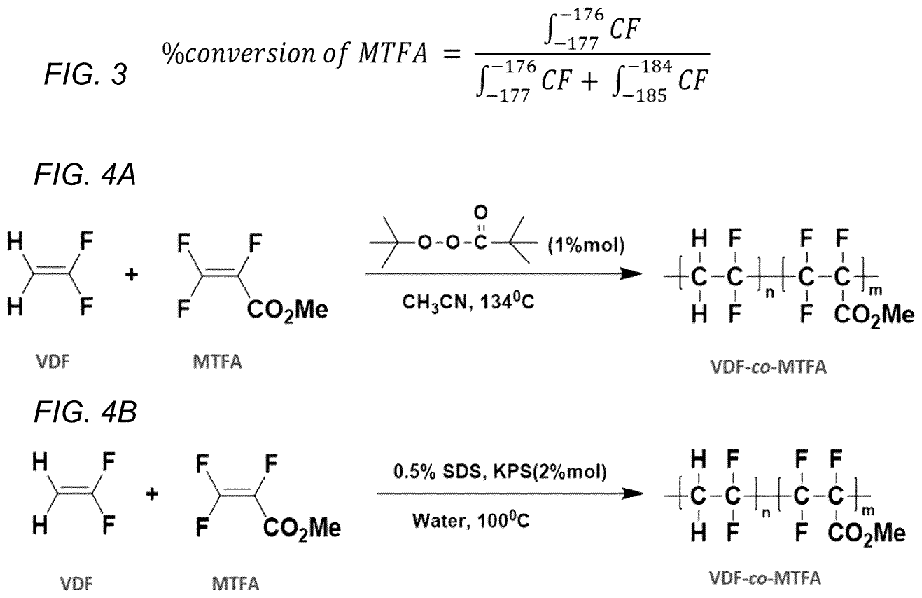

The conversion of MTFA was calculated according to the following equation shown in FIG. 3. DSC. The thermal properties of the synthesized copolymers were determined using differential scanning calorimetry (DSC). DSC measurements were conducted using DSC-1 Mettler Toledo. Scans were performed under nitrogen flow, with a temperature range from −70 to 300° C. and a heating rate of 10° C./min. Three cycles of heating-cooling-heating were performed, while the glass transition temperatures and melting points were determined by the second heating cycle. Since not all Tg appeared at the second heating cycle, some of the samples were measured from −70 to 200° C., with relatively high sample weight. Crystallization points were determined by analyzing the cooling cycle. The sample's weight was between 7-14 mg, depending on the type of functional group.

GPC. Molecular weights of the synthesized copolymers were determined using gel permeation chromatography (GPC) analysis with Varian PL-200 system loaded with Waters Styragel Column, HT 3, 10-3 Å, 10 μm, 7.8 mm×300 mm, 500-30K, and Styragel Column, HT 4, 10-4 Å, 10 μm, 7.8 mm×300 mm, 5K-600K. Dimethylformamide (DMF) (HPLC grade) with 0.05M lithium bromide (LiBr) was used as the mobile phase at 30° C. for 60 min at a flow rate of 0.8 mL min⁻¹. Samples were prepared with a concentration of 10 mg mL-1. Calibration was performed using monodispersed poly(methyl methacrylate) (PMMA) standards with molecular weight in the range of 4,600-525,000 Dalton.

TGA-MS. The thermal stability of the copolymers was measured by TGA-MS on Labsys evo with TGA (SETARAM) instrument connected to a QGA MS. The samples were heated from room temperature to 500° C. at 10° C./min under the flow of 20% O₂ in Argon at a flow rate of 30 mL min-. The gases which evolved during the measurement were analyzed using a QGA MS.

### 1.3 Synthesis of poly(VDF-co-MTFA)

### 2.3.1 General Copolymerization Procedure

All polymerization reactions were performed using 145 mL stainless steel Buchi autoclave having a maximum pressure of 60 bar, equipped with a magnetic stirrer. In order to determine the amount of VDF which is being transferred into the reactor, the VDF gas cylinder was weighed before and after the polymerization reaction (using low pressure up to 12 bar). A linear correlation was found between the pressure applied and the weight of VDF. Moreover, the pressure was controlled by using an appropriate pressure regulator. Before insertion of the materials, the system was evacuated and filled with nitrogen at least three times to remove oxygen from the system. Reagents like liquid monomers, initiator, and solvents were loaded under nitrogen flow. Then, the system was sealed and the gas was transferred into the reactor. For the final step, the reactor was inserted into a preheated oil bath.

### 1.3.2 Preparation of poly(VDF-co-MTFA) Via Conventional Radical Polymerization

A 145 mL stainless steel reactor, equipped with a magnetic stirrer was connected to vinylidene fluoride (VDF) gas cylinder via a pressure regulator. Three cycles of vacuum followed by purging with nitrogen gas, have been applied to the sealed system. In the last step, the system was purged with nitrogen gas for 5 min. Prior to use, Methyl, 2,2,3 trifluoroacrylate (MTFA) was dried under calcium hydride, distilled (under vacuum at 40° C.) and kept under molecular sieves. Under nitrogen flow, Methyl, 2,2,3 trifluoroacrylate (MTFA) (8.81 g, 62.9 mmol), tert-butyl peroxypivalate (TBPP) (0.365 g, 2.1 mmol) and 35 mL of anhydrous acetonitrile were introduced into the reactor. Next, the reactor was disconnected from the nitrogen supply and 12 bar (9.4 g, 146.8 mmol) of VDF was introduced into the reactor. Then, the reactor was immersed in a pre-heated oil bath with a temperature of 134° C. The pressure dropped immediately to 9 bar upon stirring due to the solvation of VDF in acetonitrile, and then was set at 11 bar once the reactor reached 134° C. After 48 h, the reactor was left to cool to room temperature, and the pressure dropped to 4 bar. Once the reactor reached room temperature, the unreacted VDF was gradually released. The obtained orange solution was precipitated into an ethanol bath and a white solid was recovered and dried at 50° C. in a vacuum oven. 8.768 g (47% yield) of poly(VDF-co-MTFA) copolymer was obtained.

### 2.3.3 Preparation of poly(VDF-co-MTFA) Via Emulsion Polymerization

A 145 mL stainless steel reactor, equipped with a magnetic stirrer was connected to vinylidene fluoride (VDF) gas cylinder via a pressure regulator. Three cycles of vacuum followed by purging with nitrogen gas, have been applied to the sealed system. In the last step, the system was purged with nitrogen gas for 5 min. Sodium dodecyl sulfonate (SDS) (0.175 g, 0.6 mmol) was dissolved in 35 mL of deionized water. Then, Methyl, 2,2,3 trifluoroacrylate (MTFA) (8.81 g, 62.9 mmol) was mixed with the solution for 3 min at 3500 rpm using a mixer to form the emulsion. Potassium persulfate (KSP) (1.134 g, 4.2 mmol) was added to the emulsion and the solution was stirred until complete solvation. The reaction mixture was added to the reactor under nitrogen flow, the reactor was sealed and 12 bar (9.4 g, 146.8 mmol) of VDF gas was introduced into the reactor. Then, the reactor was immersed in a pre-heated oil bath with a temperature of 100° C. The reaction was left to react and after 48 h the pressure was 4 bar. Once the reactor reached room temperature, the unreacted VDF was gradually released. Water was evaporated from the slurry and the solid white polymer was washed with concentrated HCl and subsequently with water. The polymer was then dried and purified by dissolving it in THF and precipitating it into water. Finally, the polymer was dried at 40° C. for 24 h in a vacuum oven. 6 g (35% yield) of poly(VDF-co-MTFA) was recovered.

### 1.4 Post Modification of poly(VDF-co-MTFA)

### 1.4.2 Preparation of poly(vinylidene fluoride-co-trifluoroacrylic acid) (poly(VDF-co-TFAA))

Into a 500 mL round flask, poly(VDF-co-MTFA) (3.6 g, 39.7 mmol) was dissolved in 125 mL tetrahydofurane (THF). In a different 250 mL round flask, lithium hydroxide monohydrate (LiOH×H₂O) (2 g, 47.6 mmol) was dissolved in 125 mL water. Both of the flasks were cooled separately by using an ice bath. The lithium hydroxide solution was added to the polymer solution undercooling and the reaction was left to stir overnight in room temperature. The solution turned from transparent to clear yellowish solution. The THF was evaporated, a brown solution was obtained, and the salt form of the copolymer was found to be water-soluble. To the obtained clear solution 8% HCl was added and a sticky solid started to precipitate. In acidic water, the acid form of the copolymer precipitated. The polymer was collected and dried at 30° C. in a vacuum oven. To remove the acid, after drying, the polymer was dissolved in THF and precipitated into an ice water bath. The purified polymer was then dried at 30° C. in a vacuum oven. The acid form was found to be soluble in water at room temperature. 5.1 g (93% yield) of poly(VDF-co-TFAA) was obtained.

### 2.4.3 Preparation of poly(vinylidene fluoride-co-trifluoroalcohol) poly(VDF-co-TFA)

Into a 500 mL three-necked flask, equipped with an addition funnel, glass stopcock valve, and a glass stopper, poly(VDF-co-MTFA) (6 g, 65.6 mmol) was inserted, and dried under vacuum overnight. Once dried, 160 mL of anhydrous THF was added under nitrogen flow. After the polymer was completely dissolved, the flask was cooled to 0° C. using an ice bath. Then, 42 mL of lithium borohydride (84 mmol, 2M solution in THF) was added dropwise undercooling. After the addition of the base, the flask was allowed to warm to room temperature and was left overnight to stir. The reaction was then quenched with water followed by 10% HCl addition, under cooling with an ice bath. The THF was then evaporated and a sticky white solid was formed. The solid was washed several times with water to remove the acid and then dried at 40° C. in a vacuum oven. The polymer was then purified by solvation in THF and precipitation into pentane, and then dried at 40° C. in a vacuum oven. 5.03 g (90% yield) of poly(VDF-co-TFA) had been recovered.

### 2.4.4 Preparation of poly(vinylidene fluoride-co-trifluoroacrylamide) poly(VDF-co-TFAcA)

A 145 mL stainless steel reactor equipped with a magnetic stirrer was connected to a VDF gas cylinder equipped with a pressure regulator. The system was vacuumed and purged with nitrogen gas three times before the reaction. In a 100 mL round flask poly(VDF-co-MTFA) (2 g, 21 mmol) was dissolved in 35 mL anhydrous THF. The polymeric solution was inserted into the reactor under nitrogen flow, followed by the insertion of 10 mL of anhydrous ammonia (7N in methanol). The reactor was inserted into a pre-prepared oil bath at 80° C. and the reaction was left to stir for 48 h. The reactor was allowed to cool to room temperature, and a black solution with a black precipitate was obtained. The remaining ammonia was quenched with water, the solvents were evaporated and the black solid was further dried in a vacuum oven at 40° C. 1.7 g (87% yield) of poly(VDF-co-TFAcA) was obtained.

### 2.4.5 Preparation of poly(vinylidene fluoride-co-trifluoromethoxybenzene sulfonic acid) poly(VDF-co-TFOBSA)

Into a 500 mL schlenk flask equipped with an addition funnel, poly(VDF-co-TFA) (1.54 g, 16.8 mmol) was inserted and dried under vacuum overnight. Into a 100 mL flask, triphenylphosphine (5.23 g, 19.9 mmol) and 4-Hydroxy benzenesulfonic acid (4.18 g, 23 mmol) were loaded and also dried overnight. Triphenylphosphine (Ph₃P) and 4-Hydroxy benzenesulfonic acid were dissolved in 50 mL anhydrous THF and poly(VDF-co-TFA) were dissolved in 70 mL anhydrous THF separately. Diisopropyl azodicarboxylate (DIAD) (4 g, 19.9 mmol) was added to the polymeric solution under nitrogen flow and the solution of Ph₃P and 4-Hydroxy benzenesulfonic acid has been loaded into the addition funnel and added dropwise. The clear yellowish solution became cloudy and after 1 h a white precipitate has started to appear. The reaction was left to stir for 24 h. White participate appeared and was filtered from the reaction solution. Then, the solvent was slightly evaporated and was precipitated into dichloromethane (DCM). 0.81 g (50% yield) of sticky white solid was isolated and dried under vacuum at 40° C.

### 2. Results and Discussion

### 3.1 Poly(VDF-co-MTFA) Copolymerization

In this research, we describe the copolymerization of vinylidene fluoride (VDF) monomer having the formula CH₂═CF₂ with the functional perfluorinated monomer Methyltrifluoroacrylate (MTFA) having the formula CF₂═CFCOOCH₃. The radical copolymerization was performed via conventional radical polymerization in solvent-based medium or by emulsion polymerization technique, in a water-based medium, as shown in FIG. 4.

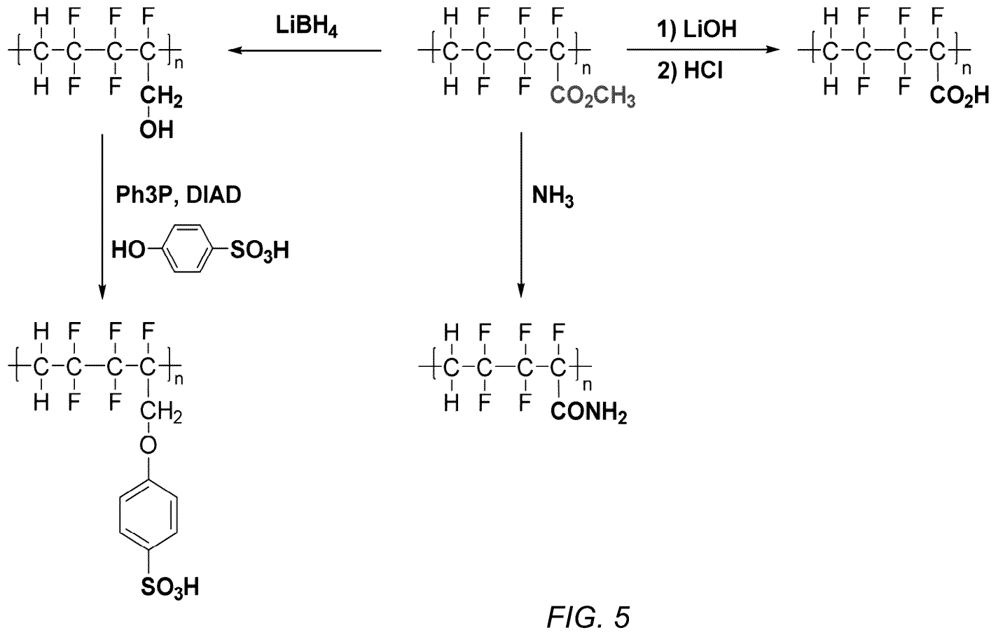

In all reactions, commercially available materials have been used and all reactions were found to be scalable. The post modifications of the ester group in poly(VDF-co-MTFA), to additional functional groups such as carboxylic acid, primary alcohol, primary amide and benzenesulfonic acid which are shown in FIG. 5 were also successful.

To determine the exact quantity of VDF that is being transferred into the reactor, the cylinder was weighed before and after the gas transfer. Several experiments under different conditions were conducted to synthesize poly(VDF-co-MTFA) via conventional radical copolymerization or emulsion polymerization, resulting in copolymers with different compositions and properties as described in Table 1.

TABLE 1
Experimental conditions for the radical copolymerization of poly(VDF-co-MTFA);

| | | | | % MTFA | % MTFA | | | | | | |
|---|---|---|---|---|---|---|---|---|---|---|---|
| | | | Applied | in the | in the | | | | | | |
| | % VDF | | VDF | copolymer | copolymer | | | | | | |
| | in the | Reaction | pressure | by | by | % MTFA | T_{g} | T_{c} | Tₘ | | |
| Entry | feed | condition | (bar) | ¹⁹FNMR | ¹HNMR | conversion | (° C.) | (° C.) | (° C.) | State | Yield |
| 1^{a} | 91 | 50° C., | 3 | 30 | 35 | 72 | — | — | — | oil | — |
| | | 24 h | | | | | | | | | |
| 2^{a} | 94 | 134° C., | 5 | 20 | 32 | 68 | — | — | — | wax | — |
| | | 24 h | | | | | | | | | |
| 3^{a} | 98 | 134° C., | 12 | 13 | 18 | 63 | −5 | 74 | 113 | solid | 8 |
| | | 24 h | | | | | | | | | |
| 4^{a} | 98 | 134° C., | 12 | 10 | 13 | 100 | −3 | 66 | 113 | solid | 11 |
| | | 48 h | | | | | | | | | |
| 5^{a} | 70 | 134° C., | 12 | 38 | 36 | 95 | 47 | — | — | solid | 47 |
| | | 48 h | | | | | | | | | |
| 6^{b} | 70 | 100° C., | 12 | 42 | 41 | — | 57 | — | — | solid | 35 |
| | | 48 h | | | | | | | | | |

^{a}Conventional radical polymerization reaction conditions: 35 mL CH₃CN, 1 mol % TBPP,
^{b}Emulsion polymerization reaction conditions: 35 mL deionized water, 0.5 mol % SDS, 2 mol % KPS

The first experiments were performed to examine the effect of the VDF molar percentage in the feed on the MTFA composition in the copolymer. As can be seen from entries 1 to 3, increasing the molar percentage of VDF in the feed, results in a decreased MTFA content in the copolymer, along with a decrease in the MTFA conversion. In addition, since MTFA did not reach full conversion in all experiments, we decided to increase the reaction time from 24 h to 48 h to examine the effect of time on its conversion (entry 3-4). If we compare entries 3 and 4, it can be seen that we have succeeded to increase the MTFA conversion from 63% to 100%, and that the composition and properties of the copolymer remained unchanged.

Although a higher amount of MTFA units were detected in the final copolymer (at low pressures) by decreasing VDF percentage in the feed, the state of matter of the copolymer produced was wax or oil. Our goal was to achieve a solid polymer with high content of the functional group and molecular weight. Obtaining waxes or oils usually indicate that low molecular weight copolymers have been produced (entries 1 and 2). According to the results, it seems that when a higher initial amount of MTFA is present, MTFA tends to cross-propagate rather than self-propagate, and by that driving VDF also to cross-propagate. Thus, we assumed that by increasing MTFA molar concentration in the feed, higher molecular weight and MTFA content in the final copolymer will be achieved. Entry 5 shows the effect of increasing MTFA molar concentration in the feed (and by that decreasing VDF molar percentage in the feed) while maintaining the same applied pressure of VDF. According to entries 4 and 5 it can be seen that we have successfully increased the amount of MTFA incorporated in the copolymer from ˜10% to 38%, with a very slight decrease in MTFA conversion. Also, the highly functional copolymer was obtained as a solid in contrast to the produced copolymers in entries 1 and 2. Moreover, the reaction yield has been increased from 11% to 47% and the highly functional copolymer (entry 5) has an amorphous structure in contrast to the former (entry 4), which has a semi-crystalline structure according to the differential scanning analysis (DSC). This means that probably when a higher amount of MTFA units are incorporated, the ester groups interfere sterically with the crystallization of VDF units. Also, the results show a significant increase in the glass transition temperature (T_{g}), when higher amounts of MTFA are incorporated in the copolymer, indicating lower mobility of the copolymer chains. Entry 6 also supports this trend since it can be seen that emulsion polymerization has been found to yield a higher percentage of functional groups (42%) and a higher Tg value of 57° C. has been observed, by implying the same molar ratio of VDF/MTFA in the feed.

Finally, the effect of increasing the VDF pressure in the feed, (while maintaining the molar ratio of VDF/MTFA as 70/30), on the copolymer composition and molecular weight, was examined. Table 2 shows the results for the synthesis of poly(VDF-co-MTFA) under different applied VDF pressure.

TABLE 2
The effect of applied VDF pressure on the composition and molecular
weight of poly(VDF-co-MTFA) with VDF/MTFA ratio of 70/30;

| | Applied | % MTFA | | | | | | | |
|---|---|---|---|---|---|---|---|---|---|
| | VDF | in the | % MTFA in | | | | | | |
| | pressure | copolymer | the copolymer | % MTFA | T_{g} | Mₙ | M_{w} | | |
| Entry | (bar) | by ¹⁹FNMR | by ¹HNMR | conversion | (° C.) | (g/mol) | (g/mol) | PDI | Yield |
| 1^{a} | 12 | 38 | 36 | 95 | 47 | 13,400 | 20,900 | 1.56 | 44 |
| 2^{a} | 20 | 36 | 34 | 80 | 46 | 33,000 | 52,000 | 1.56 | 54 |
| 3^{a} | 30 | 36 | 35 | 98 | 46 | 44,000 | 66,000 | 1.50 | 48 |
| 4^{b} | 12 | 42 | 41 | — | 57 | — | 150,000 | — | 35 |

^{a}Conventional radical polymerization reaction conditions: 35 mL CH₃CN, 1 mol % TBPP, 134° C., 48 h;
^{b}Emulsion polymerization reaction conditions: 35 mL deionized water, 0.5 mol % SDS, 2 mol % KPS, 100° C., 48 h

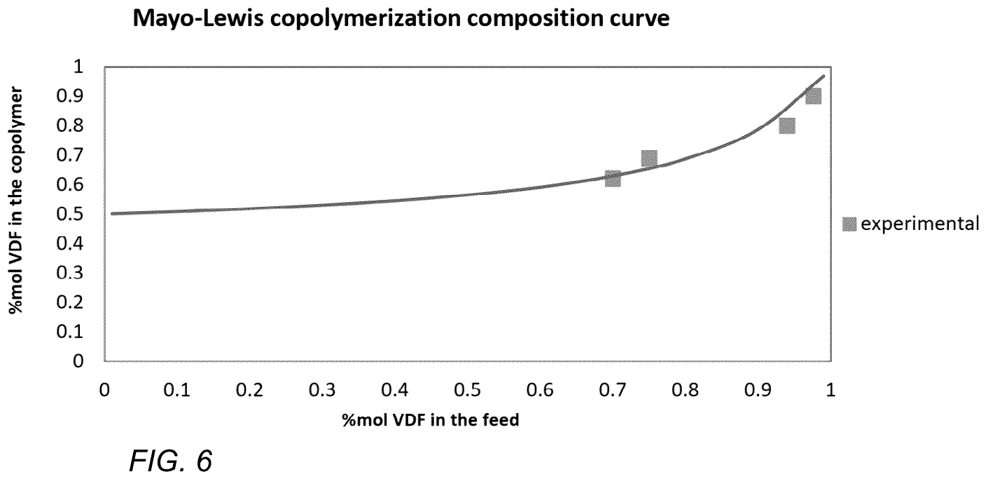

From the results given by entries 1-3 in Table 2 it can be seen that the composition of the copolymers remained the same, with very slight differences in MTFA conversions when VDF applied pressure was increased. The significance of these results is that this reaction can be scaled up, as we received increasing isolated weight of the copolymer without a change in its composition or isolated yield percentage. The molecular weights of the copolymers were determined by gel permeation chromatography (GPC) analysis, using PMMA standards, and DMF as the mobile phase. Measuring the molecular weights of fluorinated polymers is not feasible. Most of the known fluoropolymers are not soluble in common organic solvents, thus, few reported procedures or protocols are available for this kind of analysis. Even though PMMA is a hydrogenated polymer, it was chosen as a standard, since among other available standards, it was found to have the most resembled structure to poly(VDF-co-MTFA). Regarding the average molecular weight, the results show that by increasing the applied pressure of VDF in the feed, higher molecular weight copolymers can be produced. Moreover, we have observed an increase in the viscosity of reaction solution with the increase in VDF applied pressure. Thus, the increase in the molecular weight with increasing VDF pressure is probably due to fewer occurrences of termination reactions, with increasing solution viscosity. If we compare entry 1 to entry 4 it can be seen that a higher percentage of functional group was obtained (42% compared to 38%) along with very significant higher molecular weight (20,900 compared to 150,000). Thus, emulsion polymerization has been found to produce a very high molecular weight poly(VDF-co-MTFA) with higher functional group composition compared to the conventional radical polymerization method. As mentioned above, the reactivity ratios of VDF and MTFA have been found to be 0.3 and 0 respectively. According to Mayo-Lewis copolymer equation, by knowing the reactivity ratios and initial molar concentration of the two monomers in the feed, the copolymer composition can be predicted. FIG. 6 shows the calculated theoretical May-Lewis copolymer composition curve and data obtained from the experiments reported above.

From the graph in FIG. 6, it can be seen that the experimental results reported above are in good agreement with the theoretical calculations. The correspondence of the experimental results with the theoretical results has a tremendous advantage, since it allows us under the studied conditions, to tailor the composition of copolymer just by choosing the desired molar concentration of both monomers in the feed. The different copolymer compositions will eventually be manifested by different copolymer properties. The composition of poly(VDF-co-MTFA) copolymer was characterized by ¹HNMR and ¹⁹FNMR analyses. From the ¹HNMR, the signals in the range of 2.6-3.3 ppm are assigned to the methylene groups of VDF units, adjacent to VDF fluoromethylene units, which derive from normal head-to-tail additions of VDF (—CF₂CH₂CF₂CH₂—). The signal located at 2.2 ppm is assigned to the reverse addition of VDF (—CF₂CH₂CH₂CF₂—). The signal for the methyl ester is assigned at 3.9 ppm. The signals located at 0.9, 1.01, and 1.2 ppm are assigned to CH₃—(CH₂—CF₂)—, (CH₃)₃C—(CH₂—CF₂)—, and (CH₃)₃C—(CF₂—CH₂)— sequences, which are the end groups derived from TBPP initiator. According to the structure of TBPP and its suggested decomposition mechanism, four possible end groups can be formed; tBuO·, OCOtBu·, CH₃·, and tBu·. The absence of a signal at 6.3 ppm (attributed to —CH₂CF₂H unit), implies that no hydrogen transfer reaction has occurred to the macro-radical chain. Regarding the ¹⁹FNMR analysis, the characteristic signal of the fluoromethylene unit in VDF arising from normal head to tail addition, is attributed to the peak at −91 ppm (—CF₂CH₂CF₂CH₂—). The peaks located at −113.7 and −116 ppm are assigned to the fluoromethylene units in VDF, corresponding to VDF-VDF reverse addition (—CF₂CH₂CF₂CF₂CH₂—) and (—CH₂CH₂CF₂CF₂CH₂—) respectively. In addition, the peaks which are located in the range from −108 to −117 ppm are assigned to VDF fluoromethylene groups adjacent to MTFA units (—CH₂CF₂CF₂CFCOOCH₃—). The signals appearing in the range from −122 to −124 ppm are attributed to the fluoromethylene unit present in MTFA which is adjacent to VDF unit (—CH₂CF₂CF₂CFCOOCH₃—). Finally, the complex signal at about −178 ppm is assigned to the CF group of MTFA (—CH₂CF₂CF₂CFCOOCH₃—). Both Dept-135 and ¹³CNMR analyses confirm the molecular structure of poly(VDF-co-MTFA) copolymer and are complementary to the ¹⁹FNMR and ¹HNMR analyses. Pairing Dept-135 analysis with ¹³CNMR analysis is essential in order to achieve full peaks assignment. According to Dept-135 analysis, the phase positive signal located at 53 ppm corresponds to the methyl ester group derived from MTFA unit. Signals located at 31.9, 36.7, and 42.8 ppm with negative phase are assigned to the methylene groups of VDF unit. From the ¹³CNMR spectra, the signals displayed between 110 to 122.3 ppm region are attributed to the VDF and MTFA fluoromethylenes present in VDF adjacent to MTFA unit (—CH₂CF₂CF₂CFCOOCH₃—), and the signals around 90 ppm is assigned to the CF moiety in MTFA unit. It is known from the literature that the peaks which are located at 122.3 120.7, 119, and 117.5 ppm, belong to the fluoromethylene of VDF unit. Moreover, the characteristic signal for the ester carbonyl carbon appears at 164 ppm, confirming the presence of MTFA unit in the copolymer.

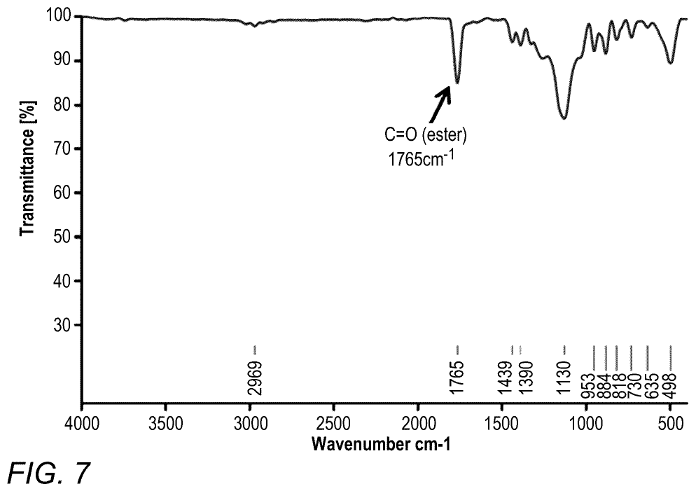

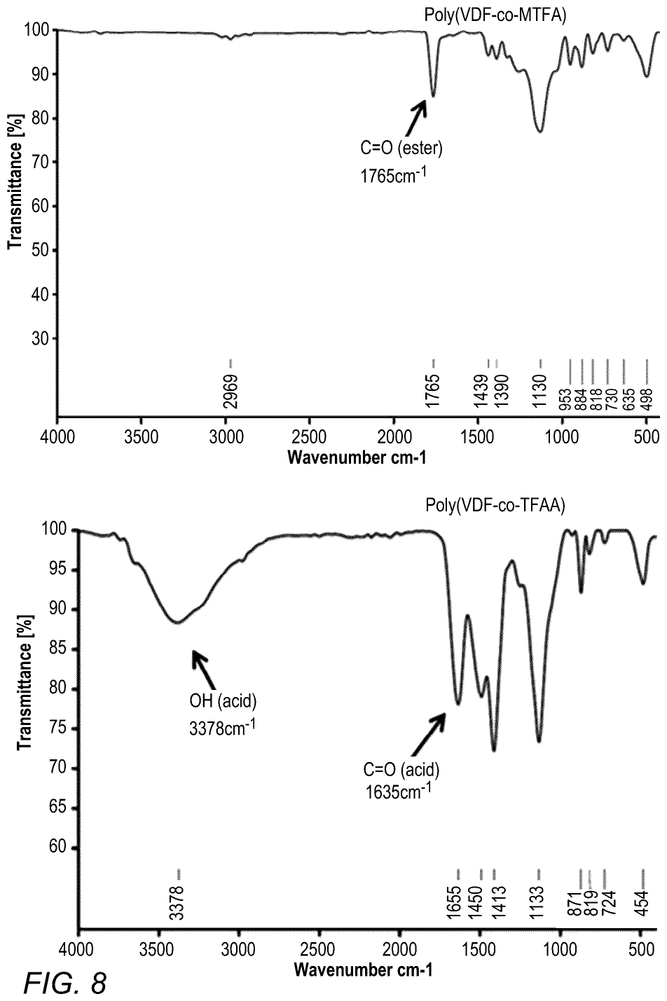

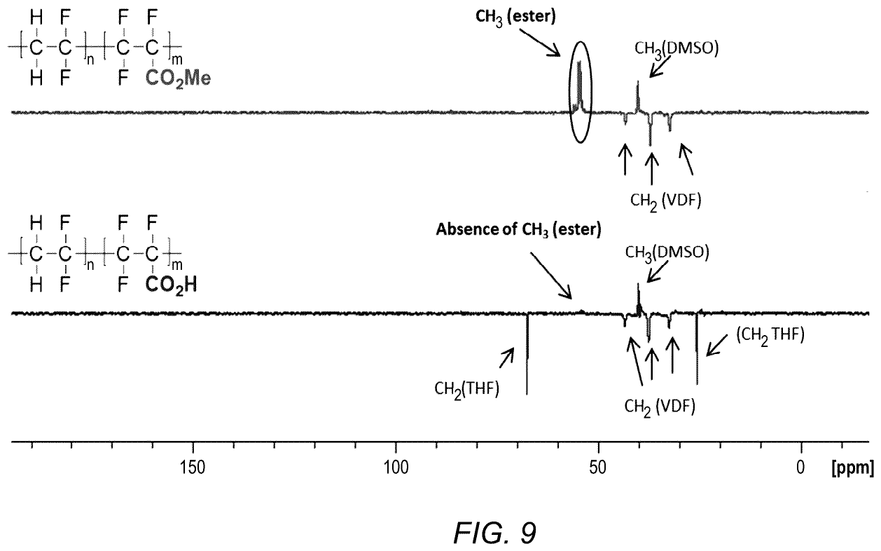

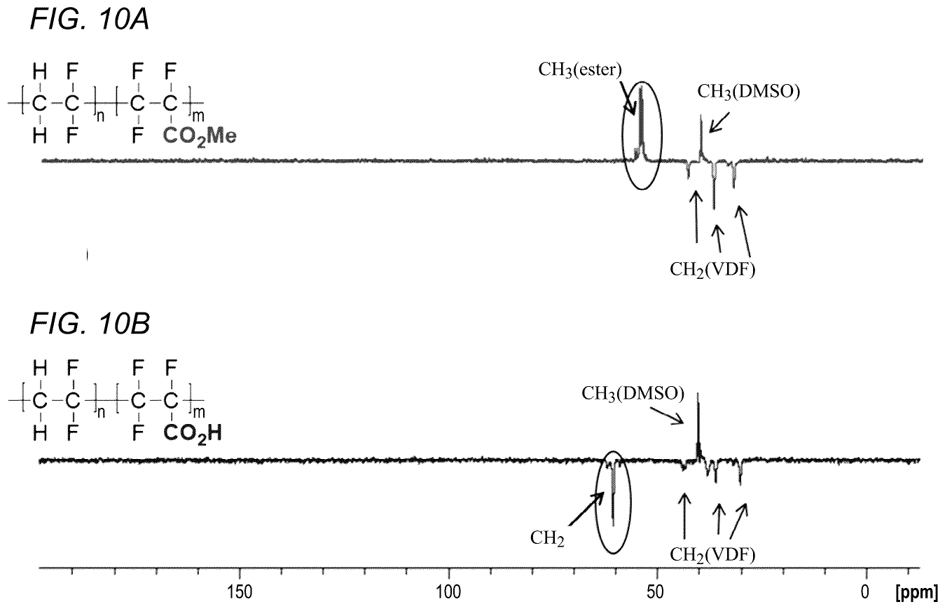

FT-IR analysis for poly(VDF-co-MTFA) was also performed to detect the presence of the ester carbonyl group, derived from MTFA unit in the copolymer. The detection of the C═O group located at 1765 cm⁻¹, which corresponds to the presence of an ester carbonyl, also confirmed the incorporation of MTFA in the copolymer as shown in FIG. 7.

### 2.2 Post Modification of Poly(VDF-co-MTFA)

The acrylate functional group was modified to different hydrophilic functional groups as shown in FIG. 5. We have succeeded to modify the ester group of poly(VDF-co-MTFA) via basic hydrolysis using lithium hydroxide as the base, with a conversion of 95%. The lithium salt form was found to be soluble in water and surprisingly, the carboxylic acid form was also soluble in water at room temperature. Thus, titration with sodium hydroxide (NaOH) was performed to determine the acid pKa. From the titration results, we found that the pKa of poly(VDF-co-TFAA) is equal to 2.71. This pKa value is similar to the pKa found for perfluoroctanoic acid (CF₃—CF₂—CF₂—CF₂—CF₂—CF₂—CF₂—CF₂—COOH), which is found to be equal to 2.8. To the best of our knowledge, no reports have been found regarding fluoropolymers with a highly fluorinated backbone that is water-soluble. Fig. shows the FT-IR analysis for poly(VDF-co-TFAA).

When the two spectra are compared, it can be seen that the peak corresponding to C═O of the ester group has shifted from 1765 cm⁻¹ to 1635 cm⁻¹, which is the characteristic peak for a carbonyl derived from a carboxylic acid. The characteristic signal that appeared at 3378 cm⁻ is attributed to the hydroxyl group of the carboxylic acid.

Error! Reference source not found.9 shows the Dept-135 analysis for poly(VDF-co-TFAA) compared to poly(VDF-co-MTFA). According to the Dept-135 analysis, it can be seen that the signal of methyl ester is absent in the poly(VDF-co-TFAA) spectra, indicating the successful hydrolysis of the ester group. The reduction of poly(VDF-co-MTFA) has yielded the alcohol form denoted as poly(VDF-co-TFA) with full conversion. According to the ¹HNMR analysis, the signal of the methylene group formed is located at 3.85 ppm and the signal arising from the hydroxyl group is located at 5.7 ppm, has the right ratio of 2:1 respectively. By adding a drop of D₂O to the NMR tube and observing the disappearance of the signal, we verified the signal attribution to the hydroxyl group. Dept-135 analysis also confirmed the successful reduction of the ester group, by observing the disappearance of the positive phase signal of the ester methyl group, and the appearance of the negative phase signal of the newly formed methylene. Dept-135 analysis of poly(VDF-co-TFA) compared to poly(VDF-co-MTFA) is shown in FIG. 0.

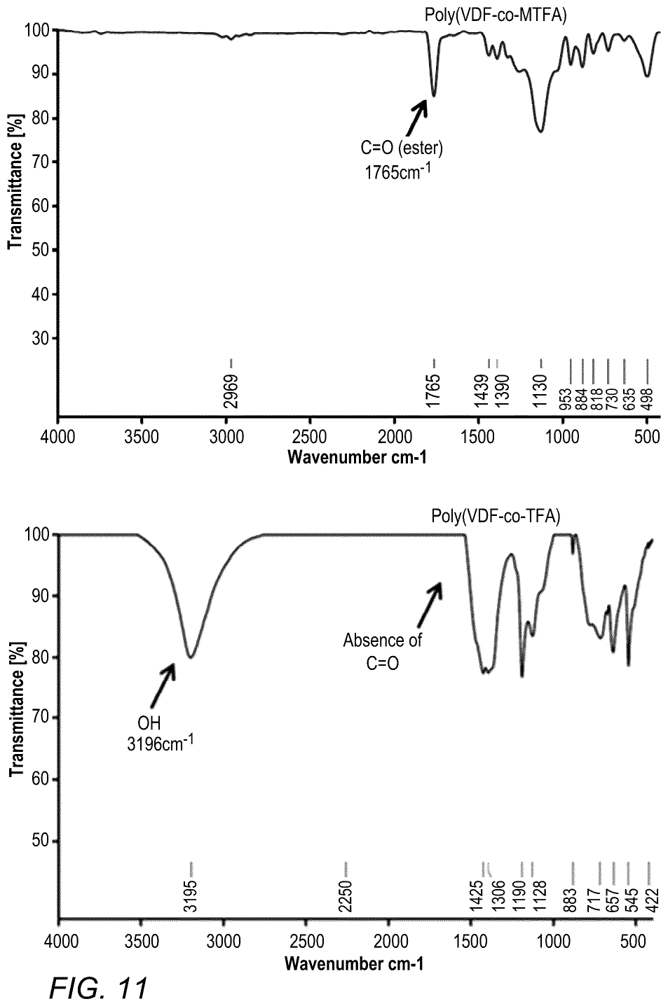

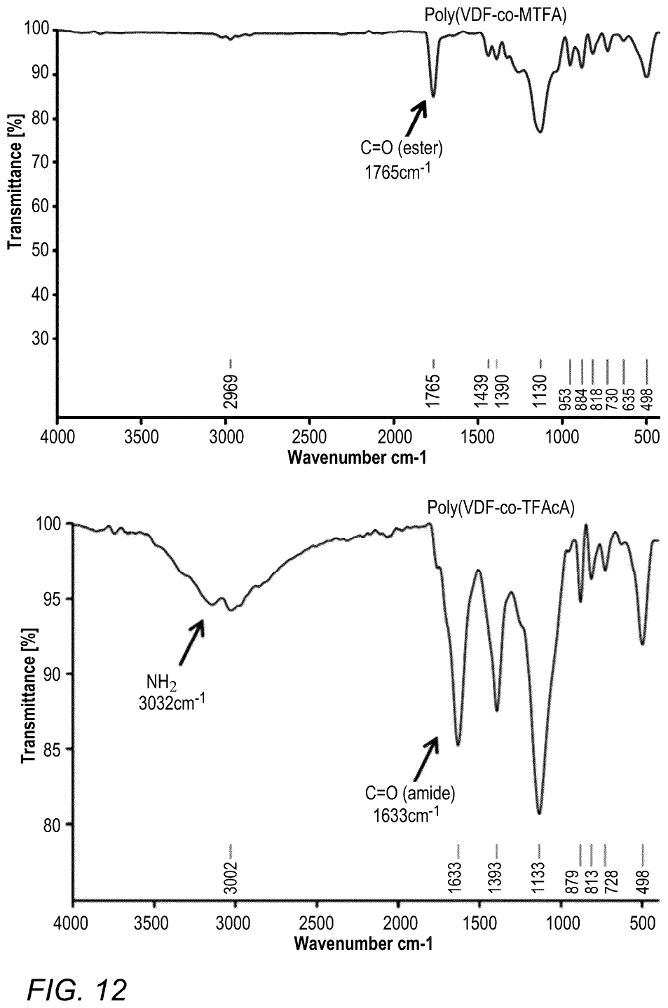

According to the ¹³CNMR, a small shift in the fluoromethine carbon (CF) has been observed (from ˜90 ppm to ˜95 ppm) due to the conversion of the functional group. Moreover, the disappearance of the ester carbonyl carbon, which was located at 164 ppm is also observed. The absence of the methyl group signal in the poly(VDF-co-TFA) ¹³CNMR spectra at 53 ppm also confirms that full conversion has been achieved. Poly(VDF-co-TFA) was also characterized by FT-IR analysis which confirmed the observations in the other analysis regarding poly(VDF-co-TFA) structure as shown in FIG. 11.

The etherification reaction of poly(VDF-co-TFA) was performed in order to insert the sulfonic acid group into the main backbone of the copolymer. We converted the hydroxyl group to benzenesulfonic acid group via the Mitsunobu reaction, as reported by Ameduri et al [2]. The obtained yield was 50% and the conversion was greater than 95%. Due to the structural resemblance between poly(VDF-co-TFA) and poly(VDF-co-TFOBSA) and the resemblance between poly(VDF-co-TFOBSA) and 4-hydroxybenzenesulfonic acid, it was necessary to achieve full conversion to verify the structure. From the ¹HNMR spectra of poly(VDF-co-TFOBSA) we concluded that full conversion was achieved, by the expected integration ratio of 1:1:1 between the two kinds of the aromatic hydrogens and the methylene group of the TFOBSA unit. According to the ¹³CNMR spectra, the signal at 60 ppm is attributed to the methylene group (—CH₂CF₂CF₂CF(CH₂OC₆H₄SO₃H)—) attached to the fluoromethine carbon (CF). The characteristic signals of the methylene fluorocarbons of the main backbone (—CH₂CF₂CF₂CF(CH₂OC₆H₄SO₃H)—), (—CH₂CF₂CF₂CF(CH₂OC₆H₄SO₃H)—), are located at 112-122 ppm range, and the fluoromethine carbon (—CH₂CF₂CF₂CF(CH₂OC₆H₄SO₃H)—) appear at 95 ppm. The methine carbons of the benzene ring appear at 114 and 127 ppm, and the quaternary carbons are located at 138 and 158 ppm. The Dept-135 spectra, confirms the presence of the methine carbons deriving from the benzenesulfonic acid ring as shown by the positive signals at 114 and 127 ppm.

The corresponding fluoropolymer bearing primary amide groups on the main backbone has been synthesized by converting the ester group on poly(VDF-co-MTFA), using ammonia for the amidation reaction. Due to the high temperature required to perform the reaction and considering that ammonia is a gas, the reaction was done in a high-pressure stainless steel reactor. Poly(VDF-co-TFAcA) was successfully synthesized with 87% yield and 70% conversion. The obtained amidated poly(VDF-co-TFAcA) copolymer was hardly soluble as compared to the other mentioned above functional copolymers. Although polymethylacryl amide (PAA) is soluble in water, poly(VDF-co-TFAcA) was found to be only slightly soluble in water, and partially soluble in acetone, methanol, and partially only in DMSO at elevated temperatures. Despite its low solubility, we have managed to obtain a sufficient ¹HNMR and ¹⁹FNMR spectra for its characterization. Unfortunately, even after several trials, we could not obtain a ¹³CNMR analysis due to the lack of sufficient solubility of the copolymer. According to the ¹HNMR spectra of poly(VDF-co-TFAcA) we concluded that the reaction did not reach full conversion due to the small peak of the methyl ester group located at 3.8 ppm. In addition, the peaks located at about 8 ppm can be attributed to the amine hydrogens.

We have calculated the conversion of the reaction from the ¹⁹FNMR spectra of poly(VDF-co-TFAcA). Next to the signal of the fluoromethine (CF) of the MTFA unit located at −176, appeared another peak located at −168 ppm, which is attributed to the fluoromethine derived from the TFAcA unit. According to the integration, the conversion to the amide group is calculated to be 70%.

In addition to the NMR analysis, FT-IR analysis has been conducted as shown in Fig. From the FT-IR analysis, it can be seen that the carbonyl ester peak at 1765 cm⁻¹ has shifted after the reaction, and a characteristic peak of an amide carbonyl at 1633 cm⁻¹ has appeared. In addition, a peak at 3032 cm⁻¹ attributed to the anime hydrogens has also appeared. This analysis also supports the structure of poly(VDF-co-TFAcA).

### 2.3 Thermal Analysis

The thermal properties of the functionalized copolymers were examined by differential scanning calorimetry (DSC) under nitrogen and thermal gravimetric analysis (TGA-MS) under argon flow. Table 3 displays the glass transition temperatures of the functionalized VDF based copolymers with functional group content of 36% in the copolymer. The enhanced solubility of the synthesized copolymers is also shown in Table 3. It can be seen that PVDF homopolymer is soluble in aggressive organic solvents whereas the functional VDF based copolymers (except for poly(VDF-co-TFOBSA)), are soluble in common organic solvents (marked in bold) such as acetone, THF etc. Moreover, the exceptional poly(VDF-co-TFAA) copolymer is soluble in water and ethanol.

TABLE 3
Glass transition temperature for functionalized VDF based copolymers

| | | T_{g} | |
|---|---|---|---|
| Polymer | Polymer structure | (° C.) | Solubility |
| PVDF | 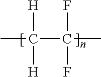 | −44 | DMF, DMSO, NMP, DMAc |
| Poly(VDF-co-MTFA) | 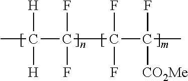 | 47 | Acetone, THF, Acetonitrile, DMSO, NMP, DMF, DMAc |
| Poly(VDF-co-TFAA) | 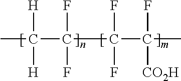 | 75 | Water (r.t), EtOH, Acetone, THF, Acetonitrile, DMF, DMSO, NMP, DMAc |
| Poly(VDF-co-TFAcA) | 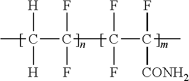 | 98 | Partially in: Acetone, DMF, MeOH, DMSO |
| Poly(VDF-co-TFA) | 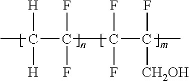 | 72 | Acetone, THF, Acetonitrile, DMSO, NMP, DMF, DMAc |
| Poly(VDF-co-TFOBSA) | 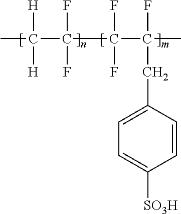 | 76 | Partially in water, THF, DMF, DMSO, NMP, DMAc |

According to the DSC analyses, all the measured copolymers did not exhibit Tm in DSC, indicating that amorphous copolymers were produced. As can be seen from Table 3, PVDF has a glass transition temperature of about −40° C., and all other functionalized copolymers exhibit a much higher value. Generally, for fluoropolymers, the obtained values are considered to be rather high. Among all copolymers, poly(VDF-co-MTFA) has the lowest T_{g}, but is still significantly higher than PVDF, probably due to the presence of the ester bulky groups in the MTFA dyad, which restrict the bonds rotations of the polymeric chains. Moreover, the higher T_{g} of all other functional groups compared to poly(VDF-co-MTFA) may be attributed to the ability to form hydrogen bonding, which is known to increase T_{g} values. As a matter of fact, measuring the T_{g} of poly(VDF-co-MTFA) was more facile as compared to the other functionalized copolymers, probably for the same reason.

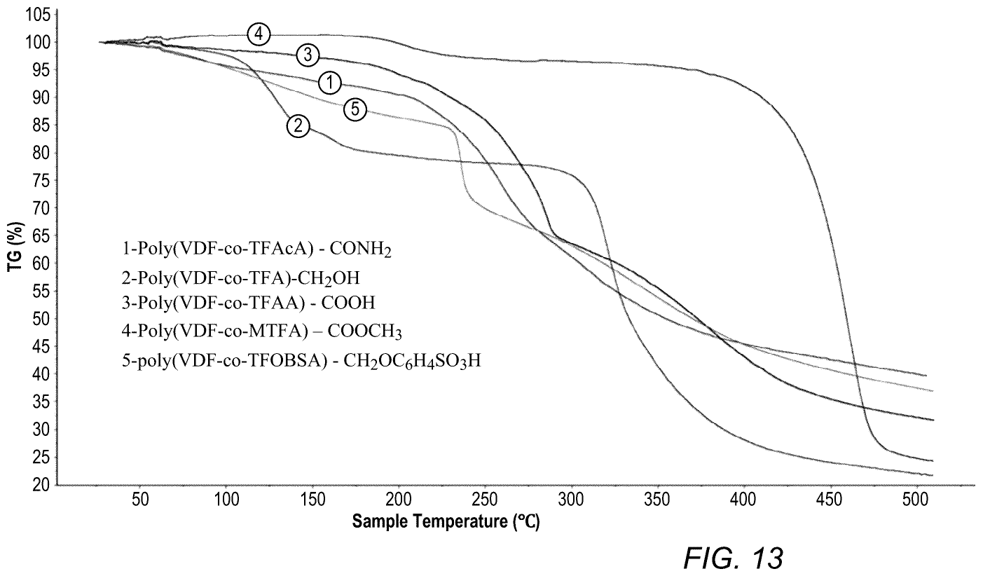

TGA-MS analysis was performed in order to examine the thermal stability of the synthesized copolymers and was compared to the thermal stability of pristine PVDF. According to the literature, PVDF homopolymer with Mₙ>400,000 gr/mol has high thermal stability with T_{d}=451° C., due to the absence of weak points such as functional groups on the main backbone. FIG. 13 displays the TGA-MS thermograms of the synthesized VDF based copolymers with different functional groups.

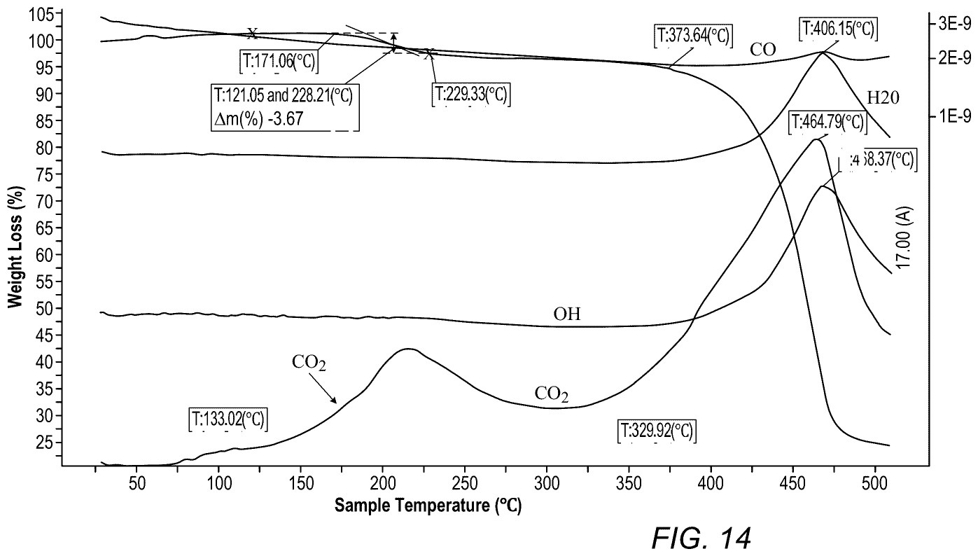

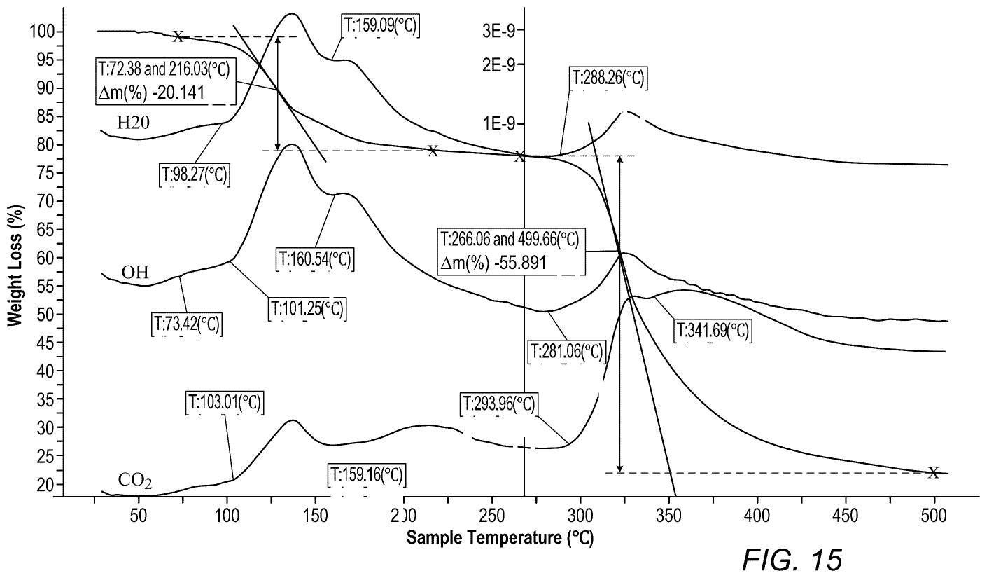

Among all copolymers, poly(VDF-co-MTFA) was found to have the highest thermal stability. The thermal degradation (depolymerization) of poly(VDF-co-MTFA) begins at 378° C., as can be seen from FIG. 14. Moreover, poly(VDF-co-MTFA) starts to decompose (˜4% weight loss) at about 133 till 228° C. releasing CO₂ according to the TGA-MS chromatogram. It should be noted that poly(VDF-co-MTFA) which was produced from the emulsion polymerization method with a higher percentage of functional groups (42%), displayed the same degradation temperature. Poly(VDF-co-TFA) also exhibits relatively high thermal stability considering the high hydroxyl content (36%), by displaying a degradation temperature of 321° C., as shown in Error! Reference source not found.15. Furthermore, Poly(VDF-co-TFA) thermogram analysis of water fragmentation by MS, showed three events in which water is released; the first stage, weakly bounded water desorption starting at 100° C., on the second stage, more tightly bounded water desorption at 160° C. (in total 20% weight loss) and the last one at 280° C., presumably to crosslinking reaction between the hydroxyl groups to form an ether bond which eliminates water. This assumption was further examined by heating Poly(VDF-co-TFA) on a heating plate till 300° C. The initial white powder exhibited discoloration after heating and was not soluble anymore in solvents which dissolved unheated Poly(VDF-co-TFA).

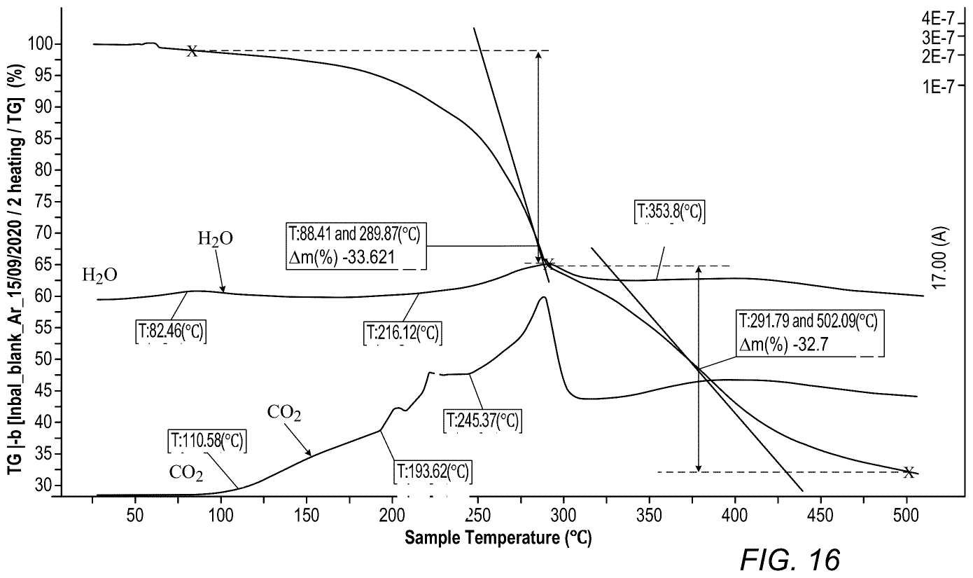

The TGA thermogram of poly(VDF-co-TFAA) shown in FIG. 16, where carboxylic acid is the substituent, exhibited a lower degradation temperature at 289° C. From the thermogram two events are observed; first is the decarboxylation and water desorption from 100° C. (33% weight loss) and the second is the beginning of the polymer degradation at 289° C.

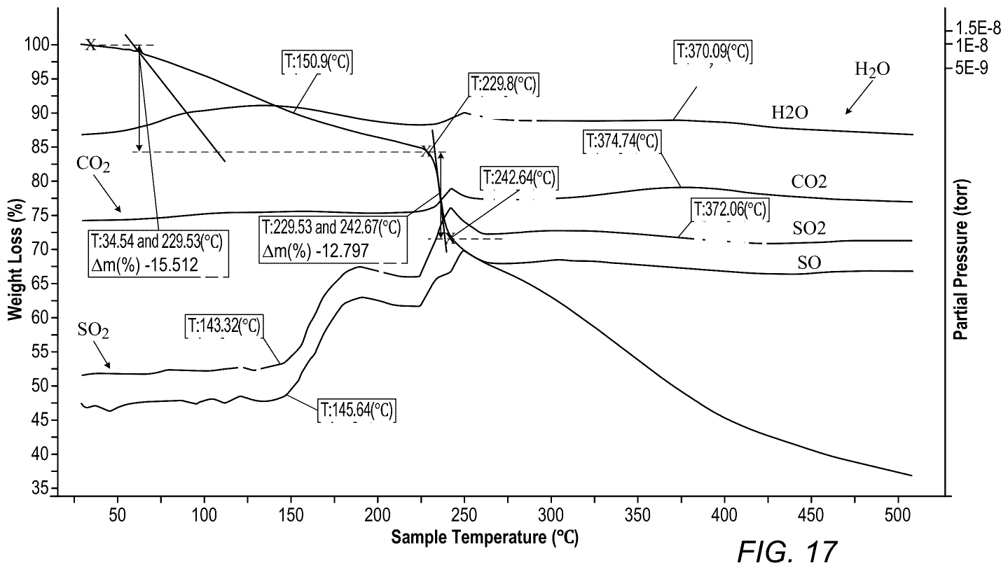

From Poly(VDF-co-TFOBSA) TGA thermogram, it was found that Poly(VDF-co-TFOBSA) has a degradation temperature of T_{d}=230° C., as shown in FIG. 17. Moreover, it can be seen from the thermogram that the first stage involves desorption of water at 100° C. (15% weight loss), followed by the release of SO₂ deriving from the sulfonic acid group.

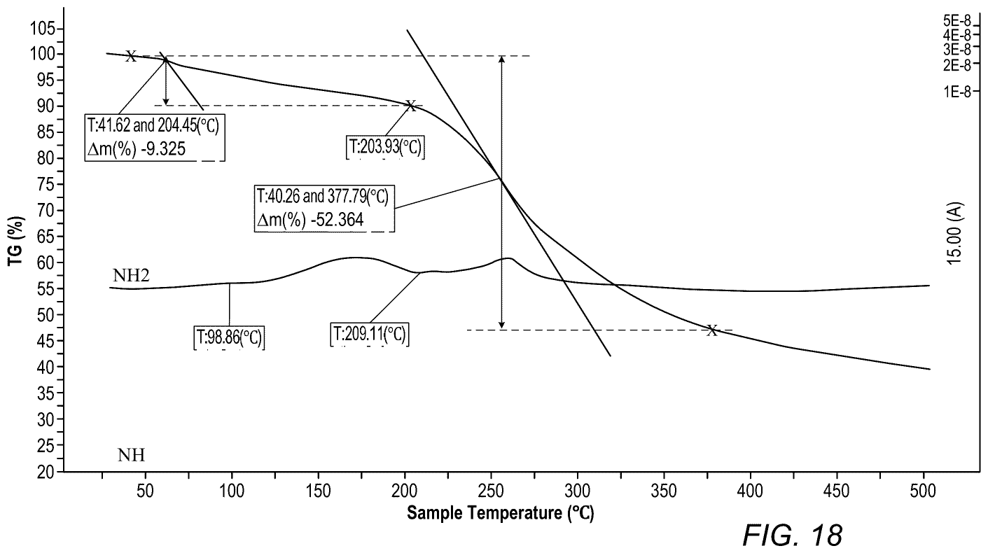

Surprisingly, the least thermally stable copolymer was found to be poly(VDF-co-TFAcA), with a degradation temperature of T_{d}=203° C., as shown in FIG. 18. The first observed weight loss (9%) involves desorption of water along with CO₂, NH₂, and NO release according to the TGA-MS analysis. As for the CO₂ release, another peak has been observed at 197° C.

In summary, all copolymers showed an amorphous structure along with relatively high T_{g}. The copolymers were found to be less thermally stable than PVDF due to the high presence of functional groups (36%) on the main backbone. A very strong dependence was found between the type of functional group to the thermal stability of the copolymer with decreasing order of COOCH₃>CH₂OH>COOH>CH₂OC₆H₄SO₃H>CONH₂, with Poly(VDF-co-MTFA) as the most thermally stable copolymer.

1-53. (canceled)

54. A copolymer represented by structure:
-[A]n-[B]m-,
wherein
A represents a unit derived from vinylidene fluoride (VDF),
n is an integer representing a number of VDF units in the copolymer,
B represents a unit derived from —C₁-C₁₀alkyl trifluoroacrylate (alkyl-TFA), and
m is an integer representing a number of alkyl-TFA units in the co-polymer;
wherein the copolymer is obtained by emulsion polymerization.

55. The copolymer according to claim 54, wherein the alkyl-TFA is methyl-TFA (MTFA), and wherein the copolymer is poly(VDF-co-MTFA).

56. A copolymer of poly(VDF-co-MTFA) having a molecular weight between 30 and 250 KDa and a degree of functionalization of about 50% or at least 50%.

57. The copolymer according to claim 54, having a structure (I): 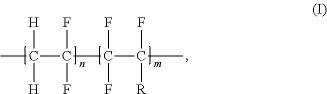
wherein
R is an atom or a group of atoms, excluding F;
n is an integer between 50 and 2,000; and
m is an integer between 50 and 1,500.

58. The copolymer according to claim 57, wherein R is —CO₂CH₃.

59. The copolymer according claim 57, wherein R is selected from Br, I, Cl, —OH, —SH, —NR₁R₂R₃, —CO₂H, —CO₂R′, —CONR₁R₂R₃, —C₁-C₁₀alkylene-OH, —C₁-C₁₀alkylene-SH, —C₁-C₁₀alkylene-NR₁R₂R₃, —OR₄, —SO₄, —S(O)—, —SO₂—, —C₁-C₁₀alkylene-OR₄, —C₁-C₁₀alkylene-SR₄, —C₁-C₁₀alkyl, —C₁-C₁₀alkylene, —C₂-C₁₀alkenyl, —C₂-C₁₀alkenylene, —C₂-C₁₀alkynyl, —C₂-C₁₀alkynylene, —C₃-C₁₀carbocyclic, —C₂-C₁₀heterocyclic, —C₆-C₁₀aryl, —C₆-C₁₀arylene, —C₂-C₁₀heteroaryl, —C₂-C₁₀-heteroarylene, —C₁-C₁₀alkylene-C₆-C₁₀aryl, —C₁-C₁₀alkylene-C₆-C₁₀arylene, —C₆-C₁₀arylene-C₁-C₁₀alkyl, —C₁-C₁₀alkylene-SO₃H, —C₆-C₁₀arylene-SO₃H, and a carbohydrate segment, wherein
each of R₁, R₂, and R₃, independently of the other, is a substituted or unsubstituted, linear or cyclic —C₁-C₆alkyl, —C₂-C₆alkylene, —C₂-C₆alkenyl, —C₂-C₆alkenylene, —C₂-C₆alkynyl, —C₂-C₆alkynylene, —C₆-C₁₀aryl, —C₆-C₁₀arylene, —C₃-C₁₀heteroaryl or —C₃-C₁₀heteroarylene groups;
R′ is selected amongst substituted or unsubstituted linear or cyclic —C₁-C₅alkyl, —C₂-C₅alkylene, —C₂-C₅alkenyl, —C₂-C₅alkenylene, —C₂-C₅alkynyl, —C₂-C₅alkynylene, —C₆-C₁₀aryl, —C₆-C₁₀arylene, —C₃-C₁₀heteroaryl and —C₃-C₁₀heteroarylene groups; and wherein
R₄ is selected from substituted or unsubstituted linear or cyclic —C₁-C₅alkyl, —C₂-C₅alkylene, —C₂-C₅alkenyl, —C₂-C₅alkenylene, —C₂-C₅alkynyl, —C₂-C₅alkynylene, —C₆-C₁₀aryl, —C₆-C₁₀arylene, —C₃-C₁₀heteroaryl and —C₃-C₁₀heteroarylene groups.

60. The copolymer according to claim 54 having structure (II): 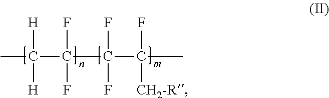
wherein
R″ is selected from Br, I, Cl, —OH, —SH, —NR₁R₂R₃, —CO₂H, —CO₂R′, —CONR₁R₂R₃, —C₁-C₁₀alkylene-OH, —C₁-C₁₀alkylene-SH, —C₁-C₁₀alkylene-NR₁R₂R₃, —OR₄, —SO₄, —S(O)—, —SO₂—, —C₁-C₁₀alkylene-OR₄, —C₁-C₁₀alkylene-SR₄, —C₁-C₁₀alkyl, —C₁-C₁₀alkylene, —C₂-C₁₀alkenyl, —C₂-C₁₀alkenylene, —C₂-C₁₀alkynyl, —C₂-C₁₀alkynylene, —C₃-C₁₀carbocyclic, —C₂-C₁₀heterocyclic, —C₆-C₁₀aryl, —C₆-C₁₀arylene, —C₂-C₁₀heteroaryl, —C₂-C₁₀-heteroarylene, —C₁-C₁₀alkylene-C₆-C₁₀aryl, —C₁-C₁₀alkylene-C₆-C₁₀arylene, —C₆-C₁₀arylene-C₁-C₁₀alkyl, —C₁-C₁₀alkylene-SO₃H, —C₆-C₁₀arylene-SO₃H, and a carbohydrate segment;
wherein each of R₁, R₂, and R₃, independently of the other, is a substituted or unsubstituted, linear or cyclic —C₁-C₆alkyl, —C₂-C₆alkylene, —C₂-C₆alkenyl, —C₂-C₆alkenylene, —C₂-C₆alkynyl, —C₂-C₆alkynylene, —C₆-C₁₀aryl, —C₆-C₁₀arylene, —C₃-C₁₀heteroaryl or —C₃-C₁₀heteroarylene groups;
wherein R′ is selected amongst substituted or unsubstituted linear or cyclic —C₁-C₅alkyl, —C₂-C₅alkylene, —C₂-C₅alkenyl, —C₂-C₅alkenylene, —C₂-C₅alkynyl, —C₂-C₅alkynylene, —C₆-C₁₀aryl, —C₆-C₁₀arylene, —C₃-C₁₀heteroaryl and —C₃-C₁₀heteroarylene groups; and
wherein R₄ is selected from substituted or unsubstituted linear or cyclic —C₁-C₅alkyl, —C₂-C₅alkylene, —C₂-C₅alkenyl, —C₂-C₅alkenylene, —C₂-C₅alkynyl, —C₂-C₅alkynylene, —C₆-C₁₀aryl, —C₆-C₁₀arylene, —C₃-C₁₀heteroaryl and —C₃-C₁₀heteroarylene groups;
wherein n is an integer between 50 and 2,000; and
wherein m is an integer between 50 and 1,500.

61. The copolymer according to claim 60, having structure (III): 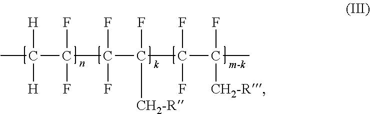
wherein
each of R″ and R′″, independently of the other, is selected from Br, I, Cl, —OH, —SH, —NR₁R₂R₃, —CO₂H, —CO₂R′, —CONR₁R₂R₃, —C₁-C₁₀alkylene-OH, —C₁-C₁₀alkylene-SH, —C₁-C₁₀alkylene-NR₁R₂R₃, —OR₄, —SO₄, —S(O)—, —SO₂—, —C₁-C₁₀alkylene-OR₄, —C₁-C₁₀alkylene-SR₄, —C₁-C₁₀alkyl, —C₁-C₁₀alkylene, —C₂-C₁₀alkenyl, —C₂-C₁₀alkenylene, —C₂-C₁₀alkynyl, —C₂-C₁₀alkynylene, —C₃-C₁₀carbocyclic, —C₂-C₁₀heterocyclic, —C₆-C₁₀aryl, —C₆-C₁₀arylene, —C₂-C₁₀heteroaryl, —C₂-C₁₀-heteroarylene, —C₁-C₁₀alkylene-C₆-C₁₀aryl, —C₁-C₁₀alkylene-C₆-C₁₀arylene, —C₆-C₁₀arylene-C₁-C₁₀alkyl, —C₁-C₁₀alkylene-SO₃H, —C₆-C₁₀arylene-SO₃H, and a carbohydrate segment;
wherein each of R₁, R₂, and R₃, independently of the other, is a substituted or unsubstituted, linear or cyclic —C₁-C₆alkyl, —C₂-C₆alkylene, —C₂-C₆alkenyl, —C₂-C₆alkenylene, —C₂-C₆alkynyl, —C₂-C₆alkynylene, —C₆-C₁₀aryl, —C₆-C₁₀arylene, —C₃-C₁₀heteroaryl or —C₃-C₁₀heteroarylene groups;
wherein R′ is selected amongst substituted or unsubstituted linear or cyclic —C₁-C₅alkyl, —C₂-C₅alkylene, —C₂-C₅alkenyl, —C₂-C₅alkenylene, —C₂-C₅alkynyl, —C₂-C₅alkynylene, —C₆-C₁₀aryl, —C₆-C₁₀arylene, —C₃-C₁₀heteroaryl and —C₃-C₁₀heteroarylene groups; and
wherein R₄ is selected from substituted or unsubstituted linear or cyclic —C₁-C₅alkyl, —C₂-C₅alkylene, —C₂-C₅alkenyl, —C₂-C₅alkenylene, —C₂-C₅alkynyl, —C₂-C₅alkynylene, —C₆-C₁₀aryl, —C₆-C₁₀arylene, —C₃-C₁₀heteroaryl and —C₃-C₁₀heteroarylene groups;
wherein n is an integer between 50 and 2,000;
wherein m is an integer between 50 and 1,500; and
wherein k is an integer equal or smaller than m.

62. The copolymer according to claim 61, wherein each of R″ and R′″ is different.

63. The copolymer according to claim 57, wherein R is —CO₂H, —CH₂OH, —CONH₂, or —CH₂O-p-phenyl-SO₃H.

64. The copolymer according to claim 60, wherein R″ is —OH or —O-p-phenyl-SO₃H.

65. The copolymer according to claim 61, wherein one or both of R″ and R′″ is —OH.

66. A process for manufacturing a copolymer of alkyl-TFA and VDF (being poly(VDF-co-alkyl-TFA)), the process comprising:
in (i) an aqueous medium free of a fluorinated surfactant, or in (ii) an organic solvent, in presence of at least one free radical initiator, reacting VDF and alkyl-TFA under conditions permitting copolymerization of alkyl-TFA and VDF to obtain poly(VDF-co-alkyl-TFA).

67. The process according to claim 66, for manufacturing a copolymer of alkyl-TFA and VDF (being poly(VDF-co-alkyl-TFA)), the process comprising:
in an aqueous medium free of a fluorinated surfactant, reacting VDF and alkyl-TFA under conditions permitting copolymerization of alkyl-TFA and VDF to obtain poly(VDF-co-alkyl-TFA).

68. The process according to claim 67, wherein the alkyl-TFA emulsion is treated with gaseous VDF under pressure.

69. The process according to claim 67, wherein the copolymer is further reacted to afford a copolymer of structure (I): 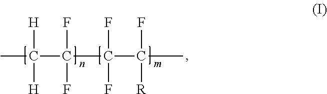
wherein
R is an atom or a group of atoms, excluding F;
n is an integer between 50 and 2,000;
m is an integer between 50 and 1,500; and wherein
R is different from —CO₂CH₃.

70. The process according to claim 66, for manufacturing a high molecular weight and highly functionalized copolymer of alkyl-TFA and VDF (being poly(VDF-co-alkyl-TFA)), process comprising:
reacting alkyl-TFA and VDF in an organic solvent, in presence of at least one free radical initiator, under conditions permitting formation of the high molecular weight and highly functionalized poly(VDF-co-alkyl-TFA copolymer.

71. The process according to claim 70, wherein the copolymer is further reacted to afford a copolymer of structure (I): 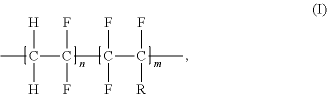
wherein
R is an atom or a group of atoms, excluding F;
n is an integer between 50 and 2,000;
m is an integer between 50 and 1,500; and wherein
R is different from —CO₂CH₃.

72. The process according to claim 66, further comprising a step of transforming the ester group in the copolymer poly(VDF-co-alkyl-TFA) to a compound of structure (I): 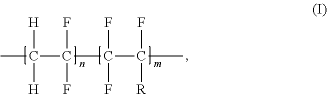
wherein
n is an integer between 50 and 2,000;
m is an integer between 50 and 1,500; and
R being different from the alkyl in said alkyl-TFA and is selected from Br, I, Cl, —OH, —SH, —NR₁R₂R₃, —CO₂H, —CO₂R′, —CONR₁R₂R₃, —C₁-C₁₀alkylene-OH, —C₁-C₁₀alkylene-SH, —C₁-C₁₀alkylene-NR₁R₂R₃, —OR₄, —SO₄, —S(O)—, —SO₂—, —C₁-C₁₀alkylene-OR₄, —C₁-C₁₀alkylene-SR₄, —C₁-C₁₀alkyl, —C₁-C₁₀alkylene, —C₂-C₁₀alkenyl, —C₂-C₁₀alkenylene, —C₂-C₁₀alkynyl, —C₂-C₁₀alkynylene, —C₃-C₁₀carbocyclic, —C₂-C₁₀heterocyclic, —C₆-C₁₀aryl, —C₆-C₁₀arylene, —C₂-C₁₀heteroaryl, —C₂-Clo-heteroarylene, —C₁-C₁₀alkylene-C₆-C₁₀aryl, —C₁-C₁₀alkylene-C₆-C₁₀arylene, —C₆-C₁₀arylene-C₁-C₁₀alkyl, —C₁-C₁₀alkylene-SO₃H, —C₆-C₁₀arylene-SO₃H, and a carbohydrate segment, wherein
each of R₁, R₂, and R₃, independently of the other, is a substituted or unsubstituted, linear or cyclic —C₁-C₆alkyl, —C₂-C₆alkylene, —C₂-C₆alkenyl, —C₂-C₆alkenylene, —C₂-C₆alkynyl, —C₂-C₆alkynylene, —C₆-C₁₀aryl, —C₆-C₁₀arylene, —C₃-C₁₀heteroaryl or —C₃-C₁₀heteroarylene groups;
R′ is selected amongst substituted or unsubstituted, linear or cyclic —C₁-C₅alkyl, —C₂-C₅alkylene, —C₂-C₅alkenyl, —C₂-C₅alkenylene, —C₂-C₅alkynyl, —C₂-C₅alkynylene, —C₆-C₁₀aryl, —C₆-C₁₀arylene, —C₃-C₁₀heteroaryl and —C₃-C₁₀heteroarylene groups; and wherein
R₄ is selected from substituted or unsubstituted, linear or cyclic —C₁-C₅alkyl, —C₂-C₅alkylene, —C₂-C₅alkenyl, —C₂-C₅alkenylene, —C₂-C₅alkynyl, —C₂-C₅alkynylene, —C₆-C₁₀aryl, —C₆-C₁₀arylene, —C₃-C₁₀heteroaryl and —C₃-C₁₀heteroarylene groups.

73. The process according to claim 72, wherein the copolymer poly(VDF-co-MTFA) is transformed to a compound of structure (V): [chemical structure]
